(19) United States
(12) Patent Application Publication
(10) Pub. No.: US 2004/0148047 A1
(43) Pub. Date: Jul. 29, 2004

(54) Hierarchical methodology for productivity measurement and improvement of productions systems

(76) Inventors: John P Dismukes, Toledo, OH (US); Qi Su, Toledo, OH (US); Samuel H Huang, Loveland, OH (US); Mousalam A Razzak, Dubai (AE); Ge wang, Holland, MI (US); Ranganath Kothamasu, Cincinnati, OH (US)

Correspondence Address: EMCH, SCHAFFER, SCHAUB & PORCELLO CO, P O BOX 916, ONE SEAGATE SUITE 1980, TOLEDO, OH, 43697

(21) Appl. No.: 10/450,863

(22) PCT Filed: Dec. 18, 2001
(86) PCT No.: PCT/US01/49332

(51) Int. Cl. G06F 19/00

(52) U.S. Cl. 700/100

(57) ABSTRACT

A hierarchical method, computer system, and computer product for causelly relating productivity to a production system to provide an integrated analysis of the system which measures, monitors, analyses and, optionally, simlates performance of the production system based on a common set of productivity metrics for throughput effictiveness, cycle time effectiveness, throughput and inventory (FIG. 5, C(ma), P(m), L(in), P(a), L(out), P(out), C(md)).

### FIELD OF THE INVENTION

This invention relates to a method, computer system, and computer product for causally relating productivity to a production system comprising describing a production system, including equipment, subsystems, product lines, manufacturing processes, factories, transportation systems, and supply chains (which includes transportation systems and manufacturing systems), developing and applying algorithms and software tools for, measurement, monitoring and analysis of system level performance, and, optionally, building a simulation model for rapid what-if scenario analysis and factory design.

### BACKGROUND OF THE INVENTION

Total Productive Maintenance (TPM) principles and. Overall Equipment Effectiveness (OEE) metrics for the productivity measurement and analysis of individual equipment have been described as follows (see end of specification for cited references):

References 8-12, 18, and 21 review OEE and provide summary level descriptions of measuring OEE of a individual equipment in a factory.

Reference 8 provides a general overview of OEE for the semiconductor industry.

Reference 9 describes a spreadsheet tool for calculating OEE of an individual piece of equipment in a factory, including how to predict improvements by changing OEE. This provides a comprehensive description at the equipment level, but does not discuss factory level performance.

Reference 10 provides a general discussion of measuring OEE for a piece of equipment, but no description of details of data collections methods or systems.

Reference 11 describes and summarizes, without details, the use of a “CUBES” tool derived from Konopka's thesis work in reference 9, to collect and analyze data on OEE for a machine in a factory.

Reference 12 provides a general description of an OEE monitoring system in a factory, including the architecture of the computer and data collection system.

Reference 18 provides a general discussion of OEE for equipment, and a spreadsheet for calculation of OEE from individual data. It is an extension of the work of Konopka to the glass industry.

Reference 20 reviews OEE definitions and applications and proposes the need for factory level productivity measurements.

References 22, 23 and 24 describe software packages for measurement of Overall Equipment Effectiveness (OEE) and analysis of root causes based on downtimes, production rates and yield.

In spite of the extensive description of equipment performance, no suitable methodology for applying OEE for processing multiple products has been presented. Even more crucial is a lack of the systematic framework and methodology for description of production systems and analysis of system level productivity in terms of equipment productivity. For example, although modeling methods such as IDEFO [25] and process mapping [26] or flow charting software (e.g. ABC Flowcharter, Visio, etc.) can be used to provide a visual representation for manufacturing flow sequence, such techniques do not systematically describe production systems and hence do not provide the quantitative basis required for calculation and analysis.

Finally, discrete even simulation software, though often applied to analysis of manufacturing performance by computer modeling, is a laborious process and lacks a systematic and standard framework and methodology for productivity measurement.

Knowledge and analysis of the productivity of manufacturing operations at the factory and supply chain level are of increasing importance to companies seeking to continuously optimize existing operations for close match of supply to market demand, and to rapidly bring new product lines through the start-up phase to highly efficient, flexible, steady state operation. In spite of the interest in equipment level productivity, no generic framework for manufacturing system description and no standard quantitative methodologies are available for description and analysis of system level productivity, and relation of system level productivity to equipment level productivity. This invention provides a sound and practically applicable method to address these needs.

Equipment Level Productivity

The Total Productive Maintenance or TPM paradigm [1-7] has provided a quantitative metric for measuring the productivity of an individual production component (equipment, machine, tool, process,. etc.) in a factory. This metric, the conventional Overall Equipment Effectiveness (OEE), calculates the equipment's productivity relative to its maximum capability,

OEE=A_{eff}*P_{eff}*Q_{eff}≦1 (1)

Thus OEE is a quantitative measure of equipment manufacturing productivity, by Equation (1), involving rate and yield as well as time. In Equation (1), A_{eff} (≦1) captures the deleterious effects due to breakdowns, setups and adjustments, P_{eff} (≦1) captures those due to reduced speed, idling and minor stoppages, and Q_{eff} (≦1) captures those due to defects, rework and yield, where,

A_{eff} (≦1)=Availability Efficiency=T_{U}/T_{T},

P_{eff} (≦1)=Performance Efficiency=NOR*SR=[T_{P}/T_{U}]*[R_{avg}/Rₜₕₐ],

and,

Q_{eff} (≦1)=Quality Efficiency=Yield of Good Product=P_{g}/Pₐ,

where NOR=net operating rate, SR=speed ratio, and the other parameters are defined in Tables 1 and 2 (FIGS. 2 and 3, respectively).

FIG. 1 defines the time parameters used in the analysis and application of OEE to the productivity of manufacturing equipment.

Following the first publication in 1988 of detailed information on the TPM methodology outside of Japan by Seichi Nakajima [1], manufacturing companies have recognized the importance of the OEE metric, and have begun applying it as part of their overall quality programs to address systematic waste elimination, continuous improvement and optimization of manufacturing processes carried out on individual production equipment. Researchers in the semiconductor chip industry [8-14] have taken the lead in these efforts, in collaboration with International SEMATECH (Austin, Tex.) and the Center for Semiconductor Manufacturing (UC Berkeley, Calif.). Published literature assessments of OEE [11-12, 15-16] indicate some typical, broad ranges of OEE in manufacturing industries, but typically cite only overall OEE numbers, providing little insight into the effect of individual manufacturing variables on the three major efficiency factors of OEE in Equation (1). More recently, researchers at The University of Toledo in collaboration with the glass industry have published analyses of OEE related to flat glass manufacturing [17-20] which include analysis of the individual factors. To date, however, there are still relatively few publications describing the theory and a standard format for application of OEE to industrial processes.

System Level Productivity

Notwithstanding the importance of the productivity of individual equipment, an understanding the productivity of a real production system (e.g. product line, factory, supply chain) typically involves the analysis and understanding of the complex layout and interconnection of many pieces of equipment. Hence the overall productivity of the system depends on many factors, including input and output schedules, inventory levels, the number of different products being processed, and the architecture for product flow between individual pieces of equipment, as well as the OEE of each equipment.

Burbidge [27-29] pioneered the recognition of the need for systematic description of factories by classifying them according to 1) type of material or product flow (continuous, discrete fabrication, or batch) and 2) type of manufacturing system integration or architecture (processing, expansive, flexible, or assembly). He concluded that in real factories one type of product flow and one type of system architecture often predominate. He also recognized that several types may be present in an actual product line or factory depending upon the complexity of manufacturing. However, Burbidge's approach has been employed for qualitative, not quantitative, description of manufacturing systems. FIG. 4 presents a matrix representing the inventor's interpretation of the Burbidge classification methodology, showing as examples the predominant classification of particular industries at the intersection between specific types of product flow and system architecture.

This analysis highlights key criteria which are prerequisites for quantitative analysis of overall factory performance, namely an accurate manufacturing layout (or flow chart), the product flow sequence, and flow rates between each equipment. Other key criteria include: 1) the availability of data on appropriate production parameters for each equipment, 2) well-defined rules for interconnecting UPP's within a manufacturing layout, 3) quantitative metrics for equipment throughput and cycle time, 4) a methodology to relate individual equipment performance to overall system performance, and 5) a sensitivity analysis methodology both for assessing root causes of poor performance and providing guidance for improvement and optimization.

Until the present invention there has been no single, well defined, proven paradigm for analysis of overall production system performance meeting these criteria. Rather, a variety of techniques have been put forward for consideration. Factory engineers and managers typically address factory analysis, improvement and optimization by empirical application of one or more tools, such as 1) simulation [30-31], 2) theory of constraints [32-33], 3) cycle time management [33], 4) continuous flow manufacturing [34], and 5) computer integrated manufacturing [36]. Therefore, there is a need to understand and alleviate the observed inverse relation between product throughput and product cycle time in the case of processing multiple part types or products or recipes.

Scott [35-36] analyzed the need for a coherent, systematic methodology for productivity measurement and analysis at the factory level. Scott examines this need from the perspective of chip manufacturing in the semiconductor industry, and suggests a weighted average of ten “overall factory effectiveness” or “OFE” metrics for evaluating the overall performance of the factory. These metrics are: 1) OEE of individual equipment, 2) cycle time efficiency, 3) on time delivery percentage, 4) capacity utilization, 5) rework percentage, 6) mechanical line yield, 7) final test yield, 8) production volume or value versus schedule, 9) inventory turn rate, and 10) start-up or ramp-up performance versus plan. The present invention meets this need for a coherent, systematic method for productivity measurement and analysis.

There is a further need to reduce these metrics to a smaller basis set of metrics, and to develop relationships between a final base set of system level metrics and the metrics describing individual equipment. Finally, there is a need for practical methodologies for application of these metrics for the analysis, improvement and optimization of manufacturing systems.

### SUMMARY OF THE INVENTION

Due to global competition, companies are striving to improve and optimize manufacturing productivity in order to achieve manufacturing excellence. One step in this effort is to develop and apply well-defined method, a computer system for, and a computer product for causally relating productivity to an array of production operations. According to the present invention, 1) a hierarchical framework is described for a production system (e.g., equipment, subsystem, product line, factory, transportation system, and supply chains (which also includes transportation systems and manufacturing systems), and 2) system performance is measured, monitored and analyzed by developing and applying algorithms and calculation methodologies, and 3) a rapid simulation of performance of the production system is built by using a common set of productivity metrics for throughput effectiveness, cycle time effectiveness, throughput and inventory.

Based on a Unit Production Process (UPP) template or building block in FIG. 5 representing a production component, equipment, machine, tool, process, and the like, algorithms are developed to calculate the unit-based Overall Equipment Effectiveness (OEE) and Cycle Time Effectiveness (CTE) at the equipment level for processing of multiple as well as single product types, in discrete or continuous production. One embodiment is the concept and methodology for unit-based OEE.

Another aspect of this invention is the description of a production system (such as a manufacturing system, factory, transportation system and/or supply chain) as an array of UPP building blocks interconnected to accurately reflect the actual material flow sequence through the system, as illustrated in FIG. 6.

Another aspect of this invention is the definition and application of a base set of well-defined UPP sub-systems, as shown in FIG. 7, with predetermined interconnectivity rules, (as shown in FIGS. 8A and 8B, Table 4). These rules are applied generically to represent any system as a basis for measurement, monitoring, analysis and simulation.

Yet another aspect is the development and application of algorithms to assess the productivity metrics of each UPP, each UPP subsystem and, finally, the production system. This hierarchical approach allows the assessment of subsystem and system level productivity metrics of Overall Throughput Effectiveness (OTE) and Cycle Time Effectiveness (CTE) from equipment level metrics by application of algorithms for subsystem and factory connections illustrated for a system, generally shown herein for ease of illustration as a Unit Factory (UF) in FIG. 6.

These assessments are applied to the productivity of each UPP, UPP subsystem, and the production system to provide an insight into the dynamics of production. This assessment includes the various loss factors and their causes in relation to performance at the UPP level, the UPP subsystem level, and, finally, the overall system level. The metrics and the analysis methodology of the present invention, therefore, provide guidance essential for achieving both near term improvements and long-term equipment and system optimization.

In yet another aspect of the present invention, measurement and analysis of real systems, for example, factories based on factory data, are conducted using spreadsheet analysis and an inventive visual flowcharting and measurement tool with the algorithms for productivity measurement at the equipment, subsystem and factory level coded in a standard computer language (e.g. Visual Basic or other suitable computer language).

Yet another aspect of the present invention is the conversion of the system flowchart description to a discrete event simulation description, to enable performance assessment by rapid simulation of various, alternative manufacturing scenarios. To do this, data representing the interconnectivity of the manufacturing system and its intrinsic performance characteristics are transferred from the flowcharting and measurement tool via appropriately formatted spreadsheets (e.g. EXCEL) to rapidly set up an equivalent manufacturing array in a discrete event simulation software package. This enables dynamic simulation to be rapidly implemented to assess scenarios for eliminating bottlenecks and tailoring performance, and to develop new designs optimized for specific manufacturing performance objectives. In a preferred aspect, the dynamic simulation is linked to market demand.

### BRIEF DESCRIPTION OF THE DRAWINGS

FIG. 1 is a schematic diagram showing the relations of time parameter definitions for a unit production process (UPP).

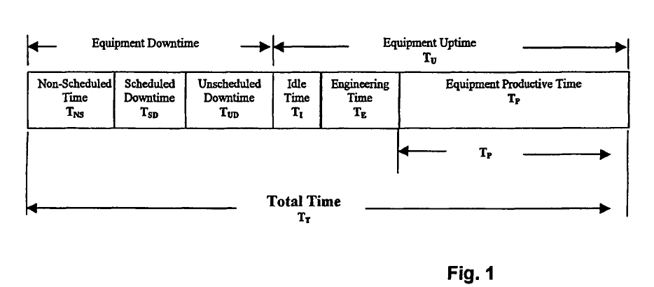

FIG. 2 is Table 1 showing parameter definitions for a Unit Production Process (UPPᵢ) used in productivity calculations.

FIGS. 3A and 3B is Table 2 showing parameter definitions and equations for calculated parameters and metrics for a UPPᵢ.

FIG. 4 is a schematic diagram of a prior art industrial classification of factories based on the type of product flow and the type of manufacturing system architecture.

FIG. 5 is a schematic illustration of a Unit Production Process (UPP) showing inputs and outputs as the basis for a manufacturing system description and productivity measurement.

FIG. 6 is a schematic illustration of a production system or unit factory (UF).

FIG. 7 is a schematic illustration of five (5) generic UPP subsystems (UPP SS). Types of factoring and describing any production system; filled circles represent individual UPPs shown in FIG. 1; note that rework may be applied to any of the 5 generic subsystems.

FIGS. 8A and 8B are schematic illustrations of examples of connection and analysis rules for UPP subsystems and productions systems.

FIGS. 9A-9E are Table 3 showing parameter definitions and equations for a production system or Unit Factory (UF) which processes multiple parts.

FIG. 10 is a schematic illustration of re-work based on a series subsystem (as shown in FIG. 7).

FIG. 11 is a table showing Example 7.1 production data, listing the products, operation sequences, theoretical processing times of a product at different UPPs, and the quantity of actual and good products being processed at four operation sequences.

FIG. 12 is a table showing Example 7.2 Measured Time at each state for UPPs.

FIG. 13 is a schematic illustration showing a modeling process for a complex manufacturing system.

FIG. 14 is a table showing examples, Case 1 and Case 2, of unit based OEE as the foundation for production metrics.

FIG. 15 is a schematic illustration of a layout of a unit factory based on series and parallel subsystems.

FIG. 16 is a schematic illustration showing the UPPs combined into subsystems.

FIG. 17A is a table showing the OEE for a series-connected UPP subsystem; FIG. 17B is a table showing the time per part data.

FIG. 18A is a table showing the OEE for a parallel-connected UPP subsystem; FIG. 18B is a table showing the time per part data.

FIG. 19A is a table showing the OEE for a unit production system or factory; FIG. 19B is a table showing the time per part data; FIG. 19C is a table showing results from both subsystems and the UPP.

FIG. 20 is a schematic illustration of a metrics calculation for an assembly subsystem.

FIG. 21A and 21B are tables showing the metric calculations of the assembly subsystem illustrated in FIG. 20.

FIG. 22 is a schematic illustration of a metrics calculation for an expansion subsystem.

FIG. 23A and 23B are tables showing the metrics calculations of the expansion subsystem illustrated in FIG. 22.

FIG. 24 is an example of an electronically generated flowchart by the EFCPMT showing 15 UPPs in series and parallel subsystem connection.

FIG. 25 is an example of an electronically generated bar chart by the EFCPMT for OEE, OTE and CTE.

FIG. 26 is a flow chart illustrating an algorithm for subsystem recognition.

FIG. 27 is a flow chart illustration A) an example manufacturing system; and, B) a graphic representation.

FIG. 28 is a flow chart illustrating recognition of a series connected subsystem.

FIG. 29 is a flow chart illustrating recognition of an expansion connected subsystem.

FIG. 30 is a flow chart illustrating recognition of a parallel connected subsystem.

FIG. 31 is a flow chart illustrating a renumbered chart of FIG. 30.

FIG. 32 is a flow chart illustrating a renumbered chart of FIG. 31.

FIG. 33 is a flow chart illustrating product information.

FIG. 34 is an example of a simulation model in EXCEL format.

FIG. 35 is an example of an imported simulation model in ARENA.

### DETAILED DESCRIPTION OF THE PREFERRED EMBODIMENT

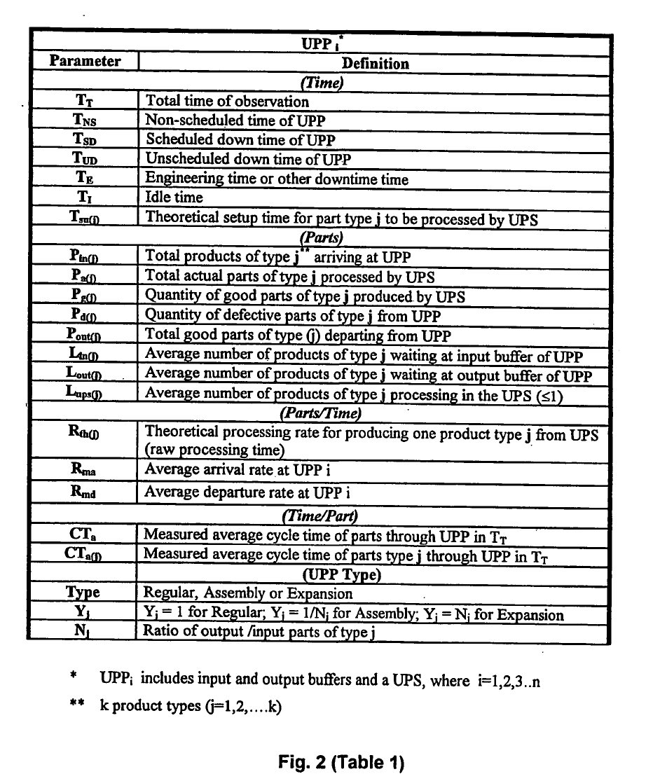

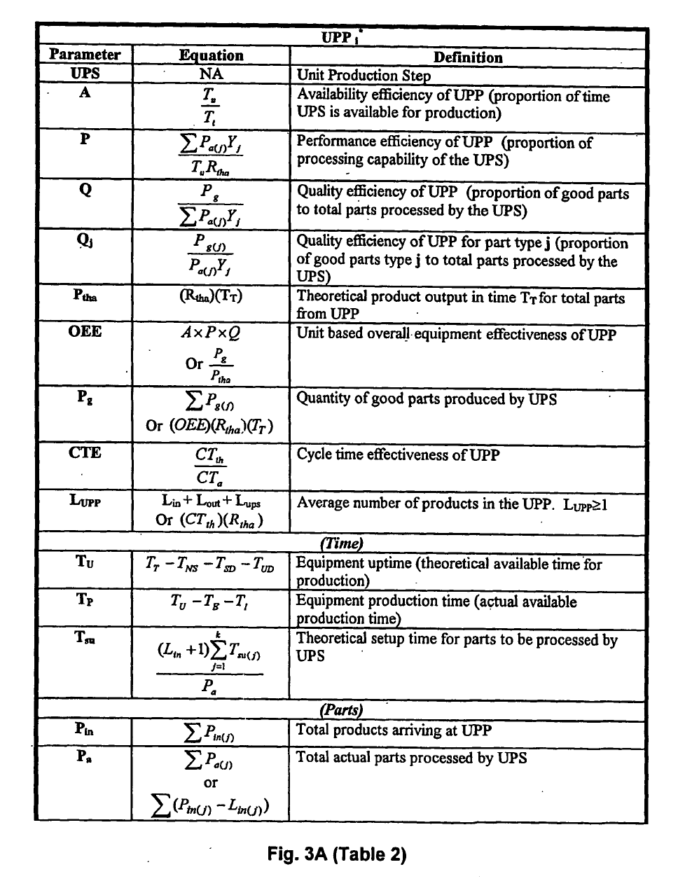

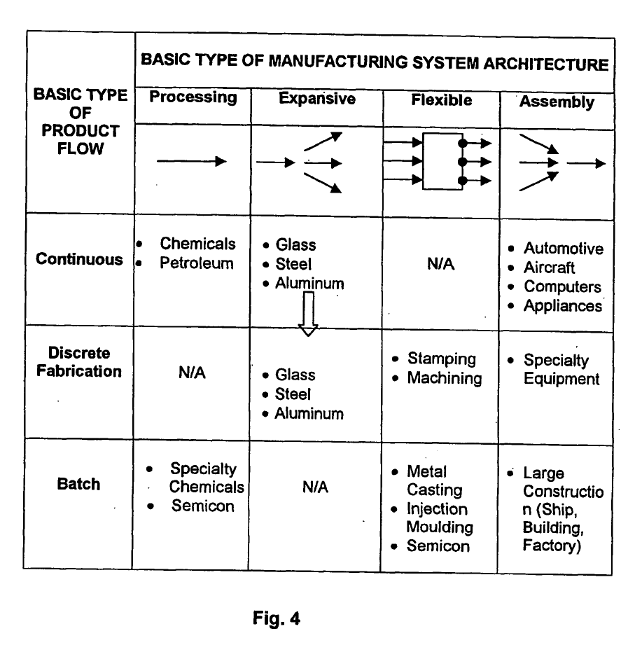

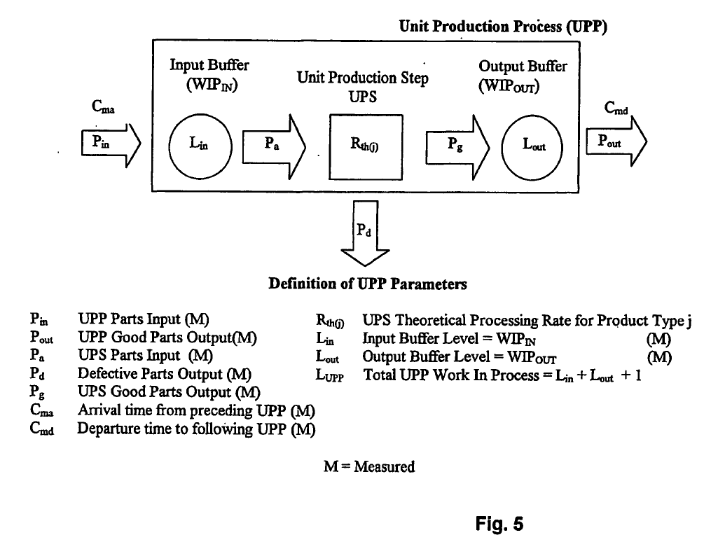

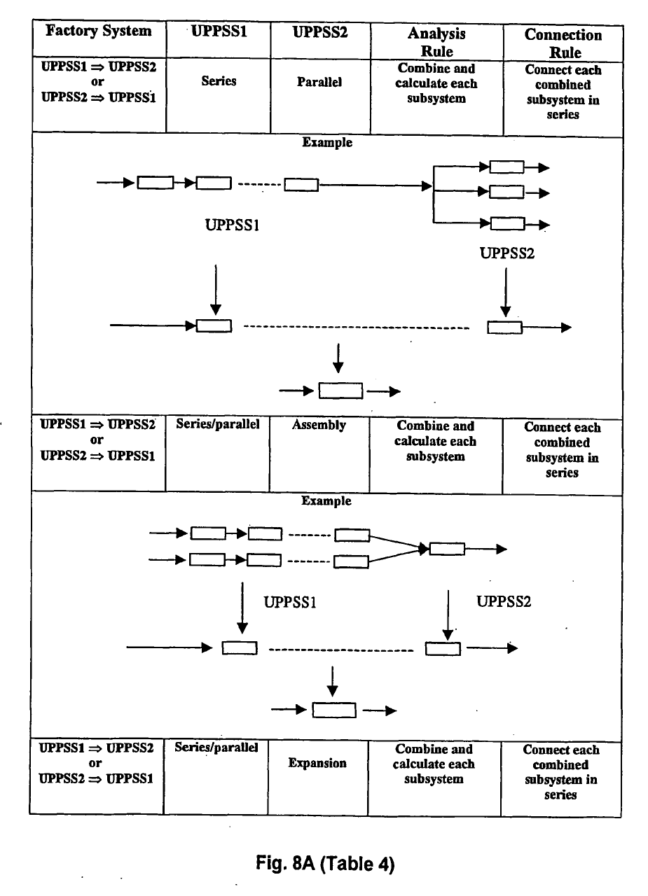

Productivity metrics for manufacturing systems or factories are of fundamental interest for systematic, quantitative determination of the effectiveness of production operations. In this invention, the Unit Production Process (UPP) illustrated schematically in FIG. 5 is the template or building block for quantitative measurement of equipment productivity, analysis of losses and determination of opportunities for performance improvement of individual equipment. In addition, the unit-based OEE metric (Section 9.1 below) together with other parameters and metrics applicable to a UPP (FIGS. 2A-2B and 3, Tables 1-2), are an embodiment for measurement of the productivity of a factory (shown in FIGS. 9A-9E, Table 3), made up of an interconnected array of UPP's and UPP subsystems, (see FIG. 6).

1. Productivity Metrics of a UPP

1.1. Overall Equipment Effectiveness (OEE) of a UPP

The UPP (FIG. 5) used as the basic equipment template for analysis consists of a unit process step (UPS) with input (Lᵢₙ) and output (Lₒᵤₜ) buffers. Based on the defining Equation (1) for OEE and the basic parameter definitions in Tables 1 and 2 (FIGS. 2A-2B and 3), demonstration of how to calculate the OEE for an UPP proceeds as follows. Note that OEE calculated for a UPP is actually based on characteristics of the UPS. Since OEE is independent of the inventory levels, this automatically reflects OEE of the UPP.

Example: Suppose during the observation period of T_{T}, that the total actual product units processed by the UPS is Pₐ. Among the Pₐ, there are k different product types and the quantity of product type j is Pₐ₍ⱼ₎, that is

$${P}_{a} = {\sum }_{j = 1}^{k} {P}_{a ( j )} .$$

The good product output (units) from the UPS is P_{g}. Among the P_{g}, the quantity of good product type j is P_{g(j)}, that is

$${P}_{g} = {\sum }_{j = 1}^{k} {P}_{g ( j )} .$$

If the theoretical processing rate (raw processing rate) of the unit processing step (UPS) for product type j is Rₜₕ₍ⱼ₎, then the theoretical average processing rate in total time T_{T} for the good product output (units) is determined by

$${R}_{thg} = \frac{{\sum }_{j = 1}^{k} {P}_{g ( j )}}{{\sum }_{j = 1}^{k} \frac{{P}_{g ( j )}}{{R}_{th ( j )}}} = \frac{{P}_{g}}{{\sum }_{j = 1}^{k} \frac{{P}_{g ( j )}}{{R}_{th ( j )}}} \qquad ( 2 )$$

Similarly, the theoretical average processing rate in total time T_{T} for actual product output (units) is determined by

$${R}_{tha} = \frac{{\sum }_{j = 1}^{k} {P}_{a ( j )}}{{\sum }_{j = 1}^{k} \frac{{P}_{a ( j )}}{{R}_{th ( j )}}} = \frac{{P}_{a}}{{\sum }_{j = 1}^{k} \frac{{P}_{a ( j )}}{{R}_{th ( j )}}} \qquad ( 3 )$$

Since the UPP might not process at its theoretical speed, thus the average actual processing rate during the time T_{P} for the actual product output is determined by

$${R}_{avg} = \frac{{\sum }_{j = 1}^{k} {P}_{a ( j )}}{{T}_{p}} = \frac{{P}_{a}}{{T}_{p}} . \qquad ( 4 )$$

and the average actual processing rate of UPP during the total time T_{T} for the actual product output is determined by

$${R}_{a} = \frac{{\sum }_{j = 1}^{k} {P}_{a ( j )}}{{T}_{T}} = \frac{{P}_{a}}{{T}_{T}} \qquad ( 4 a )$$

Thus, the availability efficiency of the UPP is calculated by

$${A}_{eff} = \frac{{T}_{u}}{{T}_{t}} , \qquad ( 5 )$$

the performance efficiency of the UPP by

$${P}_{eff} = \frac{{T}_{p}}{{T}_{u}} \times \frac{{R}_{avg}}{{R}_{tha}} , \qquad ( 6 )$$

and the quality efficiency of the UPP by

$${Q}_{eff} = \frac{{P}_{g}}{{P}_{a}} \qquad ( 7 )$$

Using Eqs.(1),(4),(5),(6),and (7), the conventional OEE defined in Equation (1) is further simplified as

$$OEE = \frac{{P}_{g}}{{P}_{tha}} = \frac{Good Product Output ( Units )}{\begin{matrix}Theoretical Actual Product \\ Output ( Units ) in Total Time\end{matrix}} . \qquad ( 8 )$$

where Pₜₕₐ=(Rₜₕₐ)(T_{T}); which is the theoretical actual product output (units) in total time T_{T}. Note, this is the maximum units can be processed by an equipment in total time T_{T}.

By the definition of Equation (8), OEE can be calculated directly from the measured P_{g} and calculated Pₜₕₐ without the use of any other factors.

This expression for OEE, which is referred to as unit-based OEE, now has a straightforward interpretation: Unit-based OEE is the good product output (units) produced by the UPP divided by the actual product output (units) which should have been produced according to the theoretical processing rate in total time observed. Note that this expression for unit-based OEE in Equation (8) mathematically equals the conventional OEE defined in Equation (1). Further discussion of the rationale for using unit based OEE rather than time based OEE as the formulation from both equipment level and system level productivity metrics is provided below.

1.2. Good Product Output (P_{g}) of a UPP

Rewriting Eqs. (8) leads to another useful expression for P_{g}, which is

P_{g}=(OEE)(Rₜₕₐ)(T_{T})

=(Overall Equipment Effectiveness)(Theoretical Average Processing Rate)(Total Time) (10)

By this definition, P_{g} is determined by unit-based OEE (or conventional OEE), theoretical average processing rate for actual product output (units) Rₜₕₐ, and total time T_{T}.

1.3. Cycle Time Efficiency (CTE) of a UPP

The cycle time of an UPP is defined as the elapsed time between arrival of a product at the UPP and the departure of the product from the UPP. The cycle time effectiveness (CTE) of the UPP is be defined as follows:

$$CTE = \frac{{CT}_{th}}{{CT}_{a}} = \frac{Theoretical Cycle Time}{Actual Cycle Time} , \qquad ( 11 )$$

where, CTₐ=the actual cycle time of UPP in total time T_{T}.

If the average number of products waiting in input buffer and output buffer during the total time T_{T} is measured, then the formula to calculate the theoretical cycle time (per part) of the UPP in total time T_{T} is written as

CTₜₕ=Max{Tₛᵤ+(Lᵢₙ+Lᵤₚₛ) Cₜₕₐ, (Lᵢₙ+Lᵤₚₛ+Lₒᵤₜ)C_{md}}, (12)

where

Lᵢₙ=average number of products waiting in input buffer;

Lₒᵤₜ=average number of products waiting in output buffer;

Lᵤₚₛ=average number of products in the UPS (FIG. 5)

$$\begin{matrix}{C}_{tha} = \frac{1}{{R}_{tha}} \\ = theoretical average processing time \\ for actual product units ;\end{matrix}$$

C_{md}=theoretical average time for product to depart from UPP; and

Tₛᵤ=theoretical total setup time for products waiting for processing in UPP.

Assume the steady state has been reached during the total time T_{T} and there is no setup time required, that is Tₛᵤ=0, then the following condition must be satisfied

Cₜₕₐ=C_{md}=Cₘₐ,

where

Cₘₐ=average time for product to arrive at the UPP.

Thus, Eq. (12) is rewritten as

$${CT}_{th} = \frac{{L}_{UPP}}{{R}_{tha}} \qquad ( 13 )$$

where

L_{UPP}=Lᵢₙ+Lᵤₚₛ+Lₒᵤₜ=average number of products in the UPP.

Note that Eq. (13) is an expression of famous Little's Queuing Formula, which equates the average number of products in UPP to the product of cycle time of the UPP and average processing rate of UPP. The theoretical cycle time (per part) of the UPP in total time T_{T} is also determined by Equation (13).

To demonstrate how to calculate the CTE for an UPP, suppose during the observation period of T_{T}, the total actual product units processed by the UPP is Pₐ, among Pₐ, there are k different product types and the quantity of product type is Pₐ₍ⱼ₎, that is

$${P}_{a} = {\sum }_{j = 1}^{k} {P}_{a ( j )} ,$$

and the product units depart from the UPP is Pₒᵤₜ. Assume there is only one setup for each product type, if the theoretical setup time for product type j is Tₛᵤ₍ⱼ₎, then the theoretical total setup time for products waiting for processing in the UPP can be determined by

$${T}_{su} = \frac{{L}_{i n} {\sum }_{j = 1}^{k} {T}_{su ( j )}}{{P}_{a}} \qquad ( 14 )$$

Without loss of generality, Lᵢₙ can be calculated as follows, assuming during the observed time period, the number of products in the input buffer changes Nᵢₙ times. The changes occur at time t₁, t₂, . . . t_{N}_{ᵢₙ}. Let Δt₍ⱼ₎=tᵢ−tᵢ₋₁, where i=1, 2, . . . , Nᵢₙ+1, t₀=0 and t_{(N}_{ᵢₙ}₃₀₁₎=Tₜ are the start and the end of the observed time period, respectively. Let L′ᵢₙ , denote the number of products in the input buffer from time tᵢ₋₁ to tᵢ. The average number of products waiting in the input buffer is determined by

$${L}_{i n} = \frac{{\sum }_{i = 1}^{{N}_{i n} + 1} {L}_{i n}^{i} Δ {t}_{( i )}}{{T}_{t}} \qquad ( 15 A )$$

Similarly, the average number of products waiting in the output buffer is determined by

$${L}_{out} = \frac{{\sum }_{i = 1}^{{N}_{out} + 1} {L}_{out}^{i} Δ {t}_{( i )}}{{T}_{t}} \qquad ( 15 B )$$

The average number of product processed at UPS, L_{UPS} is calculated as follows, assuming during the observed time period, the states of UPS are operational and idle and the states of UPS changes N_{UPS} times. The changes occur at time t₁, t₂, . . . t_{N}_{_{UPS}}. Let Δt₍ᵢ₎=tᵢ−tᵢ₋₁, where i=1, 2, . . . , N_{USP}+1, t₀=0 and t_{(N}_{_{UPS}}₊₁₎=T_{T} are the start and the end of the observed time period, respectively. Thus

$${L}_{UPS} = \frac{{\sum }_{i = 1}^{{N}_{UPS} + 1} {L}_{UPS}^{i} Δ {t}_{( i )}}{{T}_{t}} \qquad ( 15 C )$$

where

$${L}_{UPS}^{i} = \{ \begin{matrix}1 & if UPS is operational from {t}_{i - 1} to {t}_{i} \\ 0 & if UPS is idle from {t}_{i - 1} to {t}_{i}\end{matrix}$$

The theoretical average time for product to depart from UPP, C_{md}, is determined by the layout and number of material handling devices/operators serving the UPP. The actual cycle time of the UPP in total time T_{T} can be calculated by

$${CT}_{a} = \frac{{\sum }_{j = 1}^{{P}_{out}} {CT}_{a ( j )}}{{P}_{out}} \qquad ( 16 )$$

where

CTₐ₍ⱼ₎ is the measured actual cycle time of product j (jεPₒᵤₜ) in time T_{T}.

1.4. Inventory Level (L_{UPP}) of a UPP

According to Little's Law or Equation (13), average inventory level for equipment (UPP) is defined as the product of the cycle time of the UPP and average processing rate of the UPP,

L_{UPP}=(CTₜₕ)(Rₜₕₐ)

=(Cycle Time)(Theoretical Average Processing Rate) (17)

2. Productivity Metrics for a Production System or Unit Factory (UF)

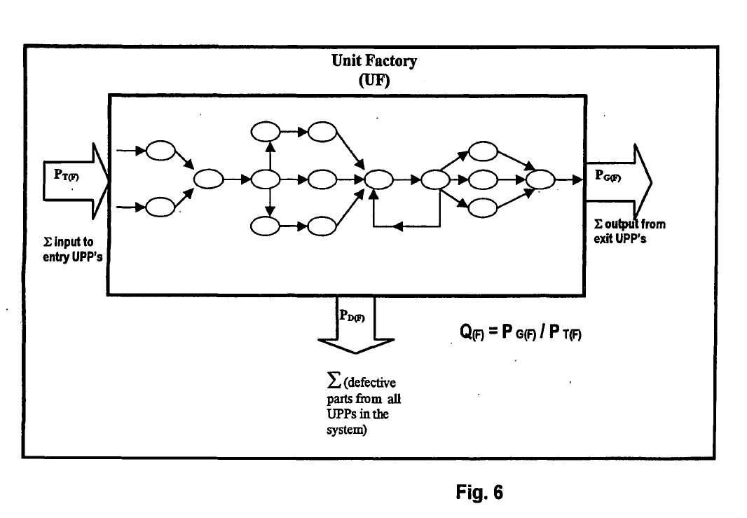

Productivity metrics for a Unit Factory (UF) are fundamentally important for determining the effectiveness of factory operation, based on the performance of each UPP and the overall layout or architecture of arrangement of the UPP's and their interconnections in the factory. Although Scott [30-31] proposed using a weighted average of ten metrics or criteria for Overall Factory Effectiveness (OFE), according to method of this invention for the analysis of system level productivity the following criteria and four basic metrics (throughput effectiveness, cycle time effectiveness, inventory, and throughput for a time T_{T}) are applied. The first criterion is to establish a unique layout or architecture for arranging all the UPP's in the production system. The second criterion is to calculate OEE and other parameters of the individual UPP's. The third is to calculate Overall Throughput Effectiveness (OTE_{F}) of the UPP subsystems and then the system. The fourth is to calculate the Good Product Output (P_{G(F)}) of the UPP subsystem and then the system. The fifth is to calculate Cycle Time Efficiency (CTE_{F}) of the UPP subsystems and then the system. The sixth is to calculate the Factory Level Inventory (L_{F}) of the UPP subsystems and then the system. For any system, the OEE of the individual UPP's is calculated as described in Section 1. Likewise, the system layout or architecture is determined by factoring the overall production system into unique combinations of UPP sub-systems shown in FIG. 7. In this section, algorithms for the OTE_{F} P_{G(F)}), CTE_{F}, and L_{F} metrics are defined and derived.

2.1. Overall Throughput Effectiveness (OTEF) of a Production System or Unit Factory (UF)

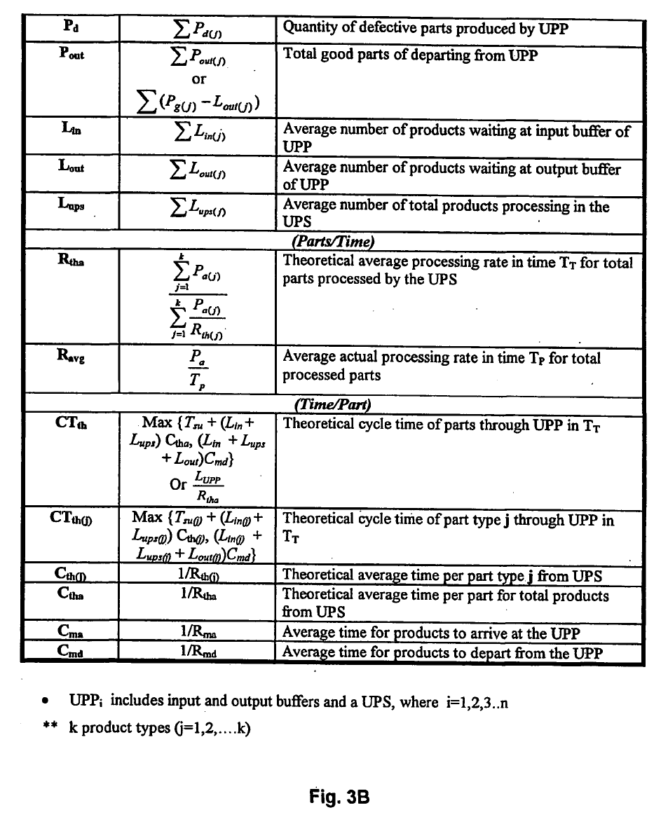

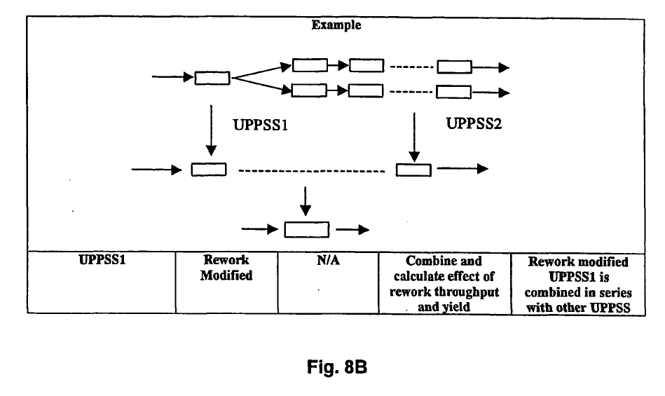

According to the analysis of Burbidge [27-29], a production system (or factory) is usually made up of one principal type of manufacturing architecture, but also includes other basic architectural types in the overall manufacturing operations, depending on industry type and which manufacturing stages are considered. The principal architecture typically reflects one of the common types of manufacturing system integration, designated in FIG. 4 as “processing”, “expansive”, “flexible”, and “assembly” configurations of individual unit production processes or UPP's. In one aspect of the present invention, all manufacturing systems are factored into five major “types” of unique UPP combinations or sub-systems, schematically defined in FIG. 7 as “series”, “parallel”, “assembly”, “expansion” (or disassembly) and “complex”, with the provision that “rework” can be applied as a modification of each of the basic subsystems, as illustrated in FIG. 10.

The overall throughput effectiveness, OTE, of each of these UPP sub-systems is uniquely calculated, and the system level overall throughput effectiveness, OTE_{F1}. is calculated in a similar manner by combining the OTE of the individual UPP sub-systems making up the system.

As a basis, therefore, for overall production system analysis, expressions for the OTE of the five major UPP sub-systems are derived, based on the OEE and other parameters of each individual UPP in the sub-system, and then the OTE of the various sub-systems are combined to obtain the OTE_{F} of the overall factory.

Example: Suppose during the observation period of T_{T}, the OEE, for each individual UPP is determined by

$$\begin{matrix}{OEE}_{( i )} = ( {A}_{eff ( i )} ) ( {P}_{eff ( i )} ) ( {Q}_{eff ( i )} ) \\ = \frac{{P}_{g}^{( i )}}{{P}_{tha}^{( i )}} i = 1 , … , n\end{matrix} \qquad ( 18 )$$

where,

P_{g}⁽ⁱ⁾=the good product output (units) of UPP i.

By extending the definition and expression in Equation (8) for the unit-based OEE of a UPP to the manufacturing system (factory) level, manufacturing system (factory) level OTE (OTE_{F}) during the period of T_{T} is defined as

$$\begin{matrix}OTE = \frac{{P}_{G ( F )}}{{P}_{TH ( F )}} \\ = \frac{\begin{matrix}Good Product Output ( Units ) \\ from System ( Factory )\end{matrix}}{\begin{matrix}Theoretical Actual Product Output ( Units ) \\ from System ( Factory ) in Total Time\end{matrix}}\end{matrix} \qquad ( 19 )$$

where

P_{THA(F)}=(R_{THA(F)})(T_{T}),is the theoretical actual product output from system in total time T_{T}. (20)

2.2. Good Product Output (P_{G(F)}) of a Production System or Unit Factory (UF)

Example: Suppose during the observation period of T_{T}, P_{g} for each individual UPP is determined by

P_{g}⁽ⁱ⁾=(OEE₍ᵢ₎)(Rₜₕₐ⁽ⁱ⁾)(T_{T}) i=1, . . . , n (21)

By using the same approach as in Section 2.1, the good product output (units) of a manufacturing system (factory) during the period of T_{T}, P_{g(F)}, is defined as

P_{G(F)}=(OTE_{F})(R_{THA(F)})(T_{T}) (22)

=(Overall Throughput Effectiveness)(Theoretical Average Processing Rate of System

(Factory)) (Total Time)

Note also that OEE₍ᵢ₎ and P_{g(i)} are all random variables. The reason is that for different observation period of T_{T} or even the same length of observation period starting at different time t, in most situations, the measured values of OEE₍ᵢ₎ and P_{g(i)} will be different because of the randomness of UPP availability. Therefore, the values of OEE₍ᵢ₎ and P_{g(i)} are not known with certainty before they are measured during the observation period of T_{T}. To be meaningful and useful, the measured values of OEE₍ᵢ₎ and P_{g(i)} must be associated with time. However, if during the observation period of T_{T}, UPPᵢ can reach steady state, then by using some statistical approaches, the expected values of OEE₍ᵢ₎ and P_{g(i)} can be determined. In addition, note also the importance of the relationship between factory architecture and the productivity metrics at the factory level.

2.3. Cycle Time Effectiveness of a Production System or Unit Factory (UF)

Example: Suppose during the observation period of T_{T}, the cycle time effectiveness, for each individual UPP is determined by

$${CTE}_{( i )} = \frac{{CT}_{th}^{( i )}}{{CT}_{a}^{( i )}} i = 1 , … , n \qquad ( 23 )$$

By using the same approach as in Section 3.1, the cycle time effectiveness for a manufacturing system (factory) is generically defined as

$$\begin{matrix}{CTE}_{F} = \frac{{CT}_{TH ( F )}}{{CT}_{A ( F )}} \\ = \frac{Theoretical Cycle Time of System ( Factory )}{Actual Cycle Time of System ( Factory )}\end{matrix} \qquad ( 24 )$$

Calculation of CTE_{F} for a specific factory requires the prior determination of the architectural arrangement of the UPP's making up the factory, the factoring of the overall arrangement into UPP sub-systems as illustrated in FIG. 7, and the calculation of CTE for these sub-systems based on the theoretical and actual cycle times.

2.4. Inventory Level (LF) of a Production System or Unit Factory (UF)

Example: Suppose during the observation period of T_{T}, the average inventory level, for each individual UPP is determined by

L_{UPP}⁽ⁱ⁾=(CTₜₕ⁽ⁱ⁾)(Rₜₕₐ⁽ⁱ⁾) i=1, . . . n (25)

By using the same approach as in Section 3.1, the manufacturing system (factory) level during the period of T_{T} is defined as

L_{F}=(CT_{TH(F)})(R_{THA(F)})

=(Cycle Time of System (Factory))(Theoretical Average Processing Rate) (26)

3. Productivity Metrics for a Series-Connected UPP Sub-System

A series sub-system consisting of n individual UPPs is illustrated in FIG. 7. Based on the theory of conservation of material flow, during the observation period of T_{T}, the good product output (units) of UPP n must equal to that of the series process. That is

P_{G(F)}=P_{g}⁽ⁿ⁾ (27)

where,

P_{g}⁽ⁿ⁾=the good product output (units) of UPP n.

Therefore,

P_{G(F)}=(OEE₍ₙ₎)(Rₜₕₐ⁽ⁿ⁾⁽T_{T}) (28)

Defining

$${Q}_{( F )} = \frac{{P}_{g}^{( n )}}{{P}_{a}^{( 1 )}} \qquad ( 29 )$$

In a series sub-system, production is dominated by the slowest UPP in the sub-system. Therefore, the theoretical average processing rate of a series sub-system in total time T_{T} for actual product output (units) is determined by

R_{THA(F)}=min{Rₜₕₐ⁽ⁱ⁾} i=1, . . . , n (30)

Using Eqs. (18), (22), (27), (28), and (30), the OTE for the sub-system is derived as

$$\begin{matrix}OTE = \frac{{P}_{G ( F )}}{{P}_{TH ( F )}} = \frac{{P}_{G ( F )}}{( {R}_{THA ( F )} ) ( {T}_{T} )} \\ = \frac{( {OEE}_{( n )} ) ( {R}_{tha}^{( N )} )}{{R}_{THA ( F )}} \\ = \frac{( {A}_{eff ( n )} ) ( {P}_{eff ( n )} ) ( {Q}_{eff ( n )} ) ( {R}_{tha}^{( n )} )}{{min}_{i} \{ {R}_{tha}^{( i )} \}}\end{matrix} \qquad ( 31 )$$

Note that the theoretical average processing rate of a series sub-system for actual product output (units) R_{THA(F)} depends on the number of product types, the theoretical processing rates of each UPP for different part types, and the observation time T_{T}.

The theoretical cycle time for a series connected UPP sub-system is therefore determined by

$${CT}_{TH ( F )} = {\sum }_{i = 1}^{n} {CT}_{th}^{( i )} + {\sum }_{i = 1}^{n} {C}_{md}^{( i )} \qquad ( 32 )$$

where Cₜₕ⁽ⁱ⁾ is described in Equation (12) and (13),

C_{md(i)}=theoretical average time for product to depart from UPP⁽ⁱ⁾ to UPP^{(iti)}.

Hence, the cycle time effectiveness (CTE) of the series connected sub-system is calculated from Equation (24), where CT_{A(F)} is calculated using Equation (16). Similarly, the inventory level (L_{F}) of the series-connected subsystem is calculated from Equation (26)

4. Productivity Metrics for a Parallel-Connected UPP Sub-System

A parallel UPP sub-system consisting of n individual UPP's is illustrated in FIG. 5. Based on the theory of conservation of material flow, during the observation period of T_{T}, the good product output (units) of all UPPs must equal to that of-the parallel sub-system, and the actual product output (units) of all UPPs must equal to that of the parallel sub-system. That is

$${P}_{G ( F )} = {\sum }_{i = 1}^{n} {P}_{g}^{( i )} \qquad ( 33 )$$

where,

P_{g}⁽ⁱ⁾=the good product output (units) of UPP i.

Therefore,

$${P}_{G ( F )} = {\sum }_{i = 1}^{n} ( {OEE}_{( i )} ) ( {R}_{tha}^{( i )} ) ( {T}_{T} ) \qquad ( 34 )$$

Defining

$${Q}_{( F )} = \frac{{\sum }_{i = 1}^{n} {P}_{g}^{( i )}}{{\sum }_{i = 1}^{n} {P}_{a}^{( i )}} \qquad ( 35 )$$

In a parallel UPP sub-system, the production rate is the summation of the production rate of each UPP in the sub-system. Thus,

$${R}_{THA ( F )} = {\sum }_{i = 1}^{n} {R}_{tha}^{( i )} \qquad ( 36 )$$

Using Eqs. (18), (22), (33), (34), and (36), the OTE for the parallel sub-system is derived as

$$\begin{matrix}OTE = \frac{{P}_{G ( F )}}{{P}_{TH ( F )}} \\ = \frac{{\sum }_{i = 1}^{n} ( {OEE}_{( i )} ) ( {R}_{tha}^{( i )} )}{{R}_{THA ( F )}} \\ = \frac{{\sum }_{i = 1}^{n} ( {A}_{eff ( i )} ) ( {P}_{eff ( i )} ) ( {Q}_{eff ( i )} ) ( {R}_{tha}^{( i )} ) \}}{{\sum }_{i = 1}^{n} {R}_{tha}^{( i )}}\end{matrix} \qquad ( 37 )$$

Note that OTE and P_{G(F)} are all random variables.

The theoretical cycle time for parallel sub-system is therefore determined by

$${CT}_{TH ( F )} = \frac{{\sum }_{i = 1}^{n} ( {P}_{a}^{( i )} ) ( {CT}_{th}^{( i )} )}{{\sum }_{i = 1}^{n} {P}_{a}^{( i )}} \qquad ( 38 )$$

where Cₜₕ⁽ⁱ⁾ is described in Equation (12) and (13).

Hence, cycle time effectiveness (CTE) of the parallel connected sub-system is calculated from Equation (24), where CT_{A(F)} is calculated using Equation (16). Similarly, the inventory level (L_{F}) of the parallel-connected subsystem can be calculated from Equation (26).

5. Productivity Metrics for an Assembly-Connected UPP Sub-System

An assembly UPP sub-system consisting of an assembly UPP (UPPₐ) and an individual upstream UPP's is illustrated in FIG. 7. Based on the theory of conservation of material flow, during the observation period of T_{T}, the good product output (units) of UPPₐ must equal to that of the assembly sub-system. That is

P_{G(F)}=P_{g}^{(a)}. (39)

Defining

$${Q}_{( F )} = \frac{{P}_{g}^{( a )}}{{P}_{a}^{( a )}} \times N = {Q}_{eff ( a )} \qquad ( 40 )$$

where,

$$N = {\sum }_{i = 1}^{n} {k}_{i} , {k}_{i} \neq 0 ;$$

kᵢ=the number of part(s) required from UPPᵢ to make a final product from UPPₐ.

Therefore,

OEE₍ₐ₎=(A_{eff(a)})(P_{eff(a)})(Q_{eff(a)}) (41)

P_{G(F)}=(OEE₍ₐ₎)(Rₜₕₐ^{(a)})(T_{T}) (42)

In an assembly UPP sub-system, production is dominated by the slowest UPP in the subsystem. Thus,

$${R}_{THA ( F )} = min \{ {min}_{i} ( \frac{{R}_{tha}^{( i )}}{{k}_{i}} ) , {R}_{tha}^{( a )} \} \qquad ( 43 )$$

Using Eqs. (18), (22), (39), (42), and (43), the OTE for the assembly sub-system is derived as

$$\begin{matrix}OTE = \frac{{P}_{G ( F )}}{{P}_{TH ( F )}} \\ = \frac{{P}_{G ( F )}}{( {R}_{THA ( F )} ) ( {T}_{T} )} \\ = \frac{( {OEE}_{( a )} ) ( {R}_{tha}^{( a )} )}{{R}_{THA ( F )}}\end{matrix} \qquad ( 44 )$$

The theoretical cycle time for assembly sub-system is therefore determined by

CT_{TH(F)}=CTₜₕ^{(a)} (45)

where Cₜₕ⁽ⁱ⁾ is described in Equation (12) and (13).

Hence, the cycle time efficiency (CTE) of the assembly connected sub-system can be calculated from Equation (45), where CT_{A(F)} is calculated using Equation (26).

6. Productivity Metrics for an Expansion-Connected UPP Sub-System

An Expansion UPP sub-system consisting of an expansive UPP (UPPₑ) and n individual downstream UPP's is illustrated in FIG. 5. Based on the theory of conservation of material flow, during the observation period of T_{T}, the good product output (units) of all UPPs must equal to that of the expansive sub-system. That is

P_{G(F)}=P_{g}^{(a)}. (46)

Defining

$${Q}_{( F )} = \frac{{P}_{g}^{( e )}}{( {P}_{a}^{( e )} ) ( N )} = {Q}_{eff ( e )} \qquad ( 47 )$$

where,

$$N = {\sum }_{i = 1}^{n} {k}_{i}$$

kᵢ=the number of part(s) produced by a part from UPPₑ, which will be sent to UPP_{i,}.

Therefore,

OEE₍ₑ₎=(A_{eff(e)})(P_{eff(e)})(Q_{eff(e)}) (48)

P_{G(F)}=(OEE₍ₑ₎)(Rₜₕₐ^{(e)})(T_{T}) (49)

In an expansive UPP sub-system, production is dominated by the slowest UPP in the sub-system. Thus,

$${R}_{THA ( F )} = min \{ {\sum }_{i = 1}^{n} {R}_{tha}^{( i )} , {R}_{tha}^{( e )} \} \qquad ( 50 )$$

Using Eqs. (18), (22), (46), (49), and (50), the OTE for the parallel expensive sub-system is derived as

$$\begin{matrix}OTE = \frac{{P}_{G ( F )}}{{P}_{TH ( F )}} \\ = \frac{{P}_{G ( F )}}{( {R}_{THA ( F )} ) ( {T}_{T} )} \\ = \frac{( {OEE}_{( e )} ) ( {R}_{tha}^{( e )} )}{{R}_{THA ( F )}}\end{matrix} \qquad ( 51 )$$

The theoretical cycle time for parallel expensive sub-system is therefore determined by

CT_{TH(F)}=CTₜₕ^{(e)} (52)

Hence, the cycle time effectiveness (CTE) of the expansive connected sub-system can be calculated from Equation (24), where CT_{A(F)} is calculated using Equation (16). Similarly, the inventory level (L_{F}) of the expansive connected sub-system is calculated from Equation (26).

7. Productivity Metrics for a Complex UPP Sub-System

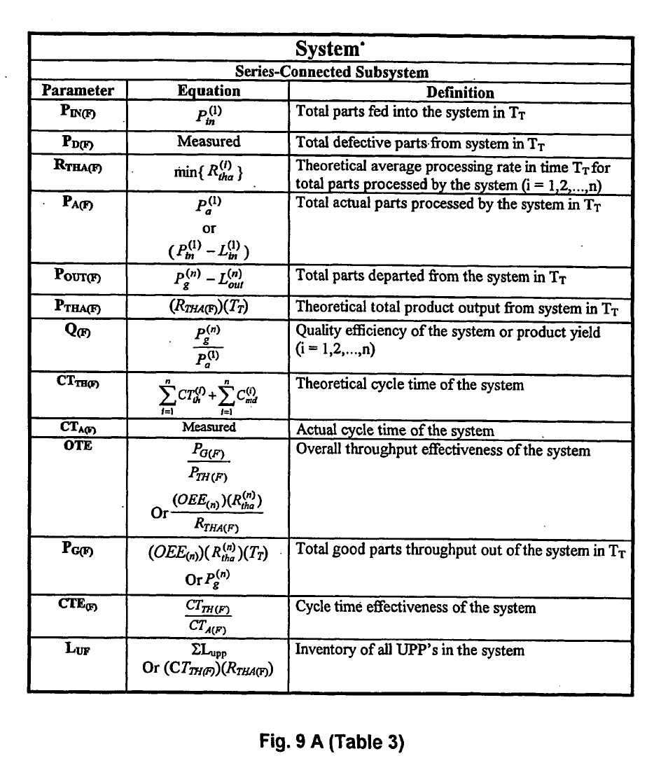

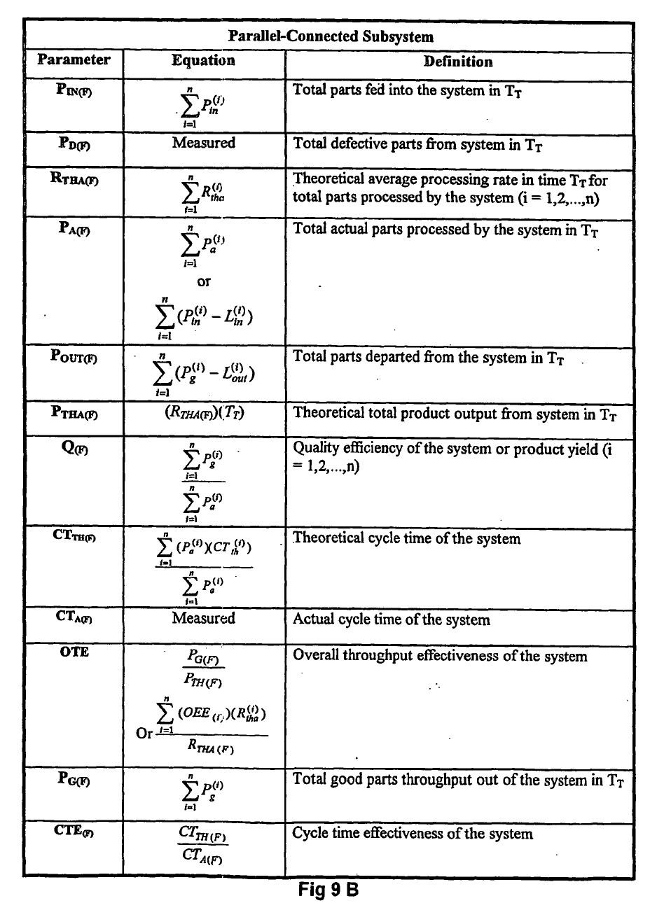

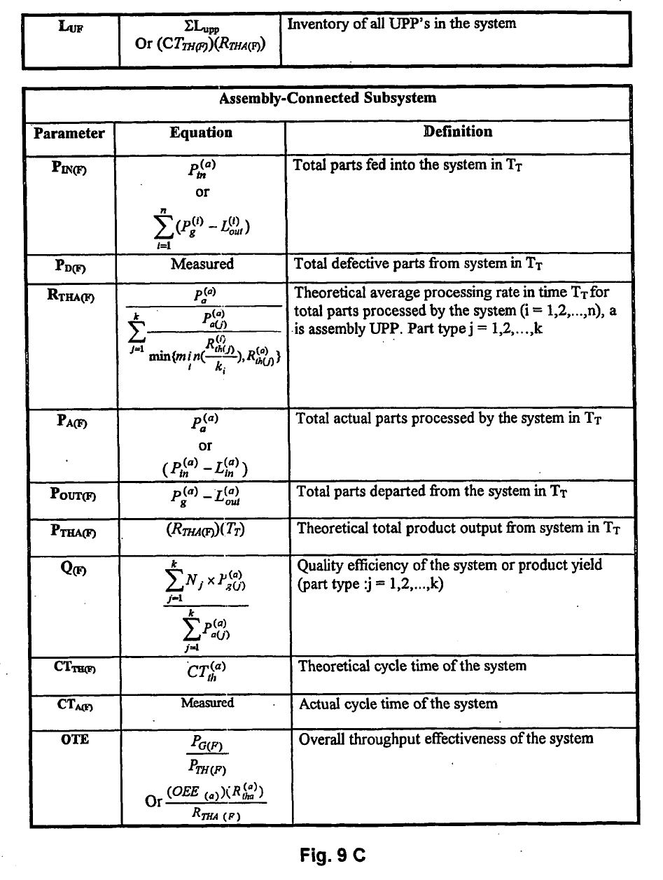

The complex manufacturing system as shown in FIG. 7 is a flexible manufacturing cell, which is called cluster tool in semiconductor industry. It consists of 5 UPPs, which are named A, B, C, D, and E respectively. During the observation period T_{T}, a batch of five different types of products, P1, P2, P3, P4, and P5 is processed. There are four operation sequences used for processing the five different products: OS1=(A, B, A, E), OS2 =(B, C, D), OS3=(A, C, D, E, C), and OS4=(C, D, E). For operation sequence 1, OS1, a product goes first to UPP A, then to UPP B, then goes back to UPP A for rework or second processing, then to UPP E, and finally exits the system. FIG. 11, Example 7.1 lists the products, operation sequences, theoretical processing times of a product at different UPPs, and the quantity of actual and good products being processing at four operation sequences. FIG. 12, Example 7.2 shows the measures times of UPPs at each of the six equipment states. According to the operation sequences and the data in Example 7.1 and Example 7.2 (FIGS. 11 and 12), the productivity metrics of the complex manufacturing system during the observation period T_{T} may be calculated by modeling the complex manufacturing system using the principle types of sub-systems as shown in FIG. 13.

In one aspect, the approach to transform and measure productivity metrics of the complex manufacturing system is summarized by the following steps:

1) Decompose the complex manufacturing system or factory into a number of the basic UPP combinations based on the UPPs in the system/factory, operation sequences, and system/factory layout.

2) Transform each of the basic UPP combinations identified in Step 1 above into an equivalent sub-system based on the method described above and calculate the productivity metrics.

3) Further transform the set of equivalent sub-systems into an equivalent system, which represents the complex system or factory, in similar manner as Step 2 above.

8. Productivity Metrics for a Series UPP Sub-System With Rework

Rework can be found in most manufacturing systems. There are several different rework scenarios. For example, every UPP in series-connected sub-system, parallel-connected sub-system, assembly-connected sub-system, and parallel expensive-connected sub-system might produce defective products, and processing defective products generated by itself or from other UPPs in the sub-systems. To demonstrate how to calculate the OTE and CTES for a rework-connected UPP sub-system, a series-connected sub-system with rework generated by the third UPP and routed to first UPP to reprocess is employed and shown in FIG. 7. Based on the theory of conservation of material flow, during the observation period of T_{T}, the good product output (units) of UPP 3 must equal to that of the rework process. That is

P_{G(F)}=P_{g}⁽³⁾. (53)

Therefore,

P_{G(F)}=(OEE₍₃₎)(Rₜₕₐ⁽³⁾)(T_{T}) (54)

Assumed that after rework, the yield of reprocessed defective parts at each UPP is 100%, the quality efficiency of each UPP is determined by

$${Q}_{eff ( i )} = \frac{{P}_{g}^{( i )}}{{P}_{a}^{( i )}} = \frac{{P}_{g}^{′ ( i )} + {P}_{d}^{( 3 )}}{{P}_{a}^{′ ( i )} + {P}_{d}^{( 3 )}} , i = 1 , 2 , 3 \qquad ( 55 )$$

where,

P_{g}′⁽ⁱ⁾=the good product output (units) of UPP i from the actual good product units processed by UPP i;

Pₐ′⁽ⁱ⁾=the actual good product units processed by UPP i, and

P_{d}⁽³⁾=the defective product units produced by UPP 3, which are routed to UPP1 for rework.

In a series sub-system with rework, production is dominated by the slowest UPP in the sub-system. Therefore the theoretical average processing rate of a series sub-system with rework in total time T_{T} for actual product output (units) is determined by

R_{THA(F)}=min{Rₜₕₐ⁽ⁱ⁾} i=1, . . . , 3 (56)

Using Eqs. (18), (22), (53), (54), and (56), the OTE for the sub-system is derived as

$$\begin{matrix}OTE = \frac{{P}_{G ( F )}}{{P}_{TH ( F )}} \\ = \frac{{P}_{G ( F )}}{( {R}_{THA ( F )} ) ( {T}_{T} )} \\ = \frac{( {OEE}_{( 3 )} ) ( {R}_{tha}^{( 3 )} )}{{R}_{THA ( F )}} \\ = \frac{( {A}_{eff ( 3 )} ) ( {P}_{eff ( 3 )} ) ( {Q}_{eff ( 3 )} ) ( {R}_{tha}^{( 3 )} )}{{min}_{i} \{ {R}_{tha}^{( i )} \}}\end{matrix} \qquad ( 57 )$$

Note that during the observation time T_{T}, the expression of OTE formula for a series sub-system with rework is exact the same as that of a series sub-system except for the different definition of quality efficiency, which includes rework. This conclusion is applicable to the other rework scenarios.

The theoretical cycle time for the series sub-system with rework is applicable therefore determined by the same equation for series sub-system, that is Eq. (32). Similarly, the inventory level-(L_{F}) of the parallel expensive connected sub-system is calculated from Equation (26).

9. Unit-Based OEE as the Foundation For Productivity Metrics

Note that if the average theoretical processing rate for actual product output (units), Rₜₕₐ is equal to R_{thg}, the average theoretical processing rate for good product output (units), then OEE is expressed as:

$$OEE = \frac{{T}_{g}}{{T}_{T}} = \frac{\begin{matrix}Theoretical Production Time \\ for Good Product Output\end{matrix}}{Total time} , \qquad ( 9 )$$

where,

$${T}_{g} = \frac{{P}_{g}}{{R}_{thg}} = \frac{Good Product Output}{\begin{matrix}Average Theoretical Processing Rate \\ for Good Product Output\end{matrix}}$$

The time-based OEE defined in Equation (9) is the metric developed by Leachman [13]. This interpretation of OEE differs from the unit-based definition given in Equation 8. As the names indicate, the difference between unit-based and time-based OEE lies in the emphasis on mass-balanced product throughput (unit-based) or on time utilization (time-based).

To illustrate this, the three factors composing OEE are examined: Availability, Performance and Quality. Availability and Performance efficiency (Equations 5 and 6) are the same for both unit-based and time-based definitions. Quality, however, is defined differently. Unit-based Quality efficiency does not differentiate between different part types. As shown in Equation (7) it is simply the ratio of total good parts produced to total parts produced:

$$Q = \frac{{\sum }_{j = 1}^{k} {P}_{g ( j )}}{{\sum }_{j = 1}^{k} {P}_{a ( j )}}$$

Time-based quality efficiency, on the other hand, weights each part type processed in the machine by the individual processing rate for each part:

$$Q = \frac{{\sum }_{j = 1}^{k} \frac{{P}_{g ( j )}}{{R}_{th ( j )}}}{{{\sum }_{j = 1}}^{k} \frac{{P}_{a ( j )}}{{R}_{th ( j )}}}$$

Since OEE is the product of the three factors (A, P and Q), it follows that OEE in general will have two different values depending on whether unit-based or time-based quality definition is used.

The advantages of using unit-based OEE can be summarized as follows: 1) unit-based OEE mathematically equals to the conventional OEE defined in Equation (1). Time-based OEE, however does not; 2) due to the nature of mass balance, unit-based OEE is directly related to productivity; 3) unit-based OEE lays the foundation to define and measure the factory level productivity as discussed herein.

Note, however, that unit-based OEE and time-based OEE are mathematically identical under any of the following special conditions:

Only one product type is being processed by the UPP during time T_{T},

The theoretical raw processing rates are equal for all product types processed by the UPP

during time T_{T}

Rₜₕ₍₁₎=Rₜₕ₍₂₎=. . . Rₜₕ₍ⱼ₎=Rₜₕ₍ₖ₎

The Quality ratios are evenly distributed among product types

$$\frac{{P}_{g ( 1 )}}{{P}_{a ( 1 )}} = \frac{{P}_{g ( 2 )}}{{P}_{a ( 2 )}} = \frac{{P}_{g ( j )}}{{P}_{a ( j )}} = Λ = \frac{{P}_{g ( k )}}{{P}_{a ( k )}}$$

The yield of all product types during time T_{T} is 100% P_{g}=Pₐ

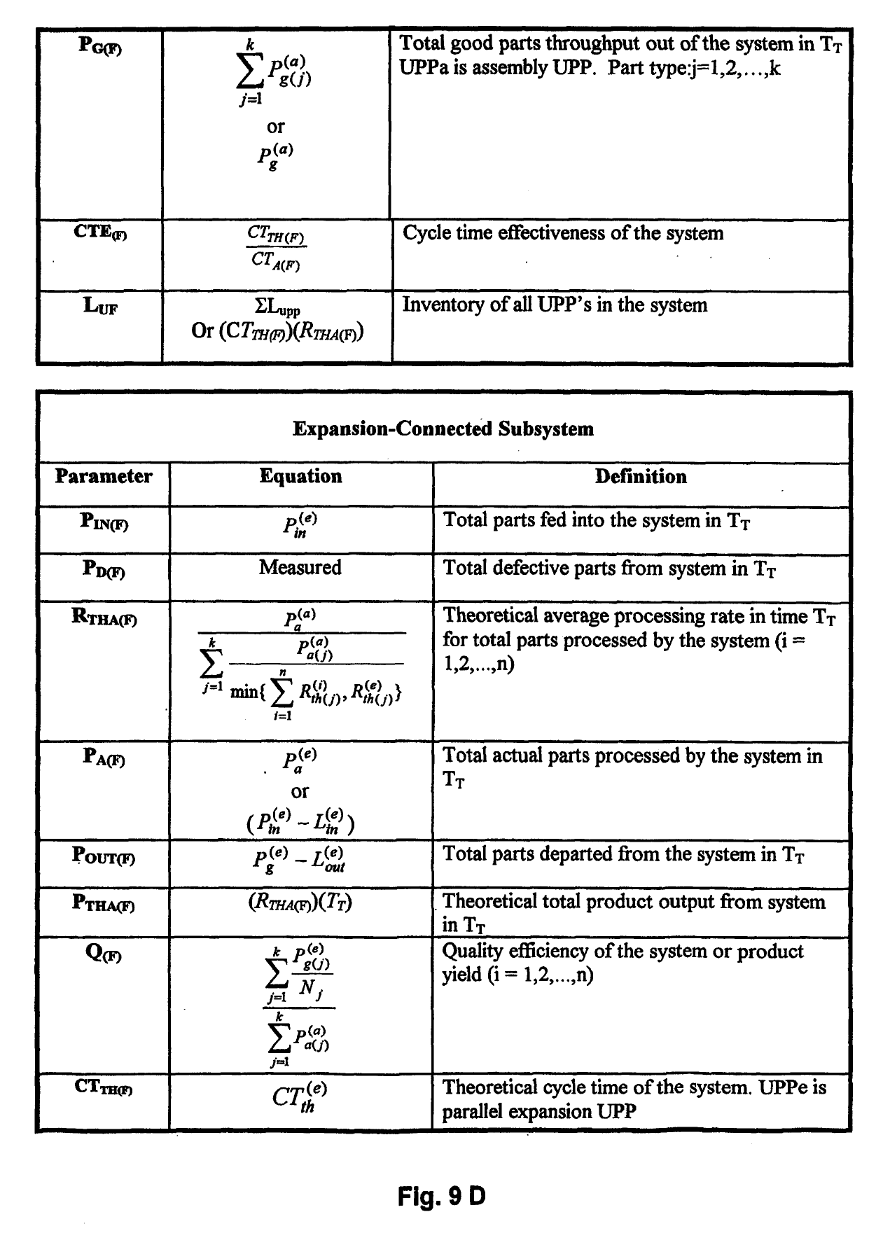

To illustrate this two examples as shown in FIG. 14, Table 4. In Case 1 the UPP produces two part types (X and Y) each at a different processing rate. In Case 2, the processing rates are identical for both part types. By examining the FIG. 14 it is clearly seen that in Case 1 the unit-based quality is different from that of time-based quality and so are the OEE values. Case 2 illustrates one of the above described “special conditions” where equal processing rates result in equal quality efficiencies and OEE for both unit-based and time-based metrics.

10. Connection and Analysis Rules to Calculate Productivity Metrics of UPP Subsystems and Factory Systems

The framework for description and analysis of productivity according to this invention can be summarized as follows: FIG. 5 defines a Unit Production Process (UPP), the basis for analysis of equipment productivity. FIG. 6 defines a Factory System or Unit Factory (UF) consisting of a number of UPPs interconnected in a sequence experimentally determined by the sequence of material flow.

An embodiment of this invention is that the performance of any factory system, flow charted as an interconnected array of UPPs, can be measured and analyzed based on the five (5) basic types of UPP interconnectivity illustrated in FIG. 7. This is achieved through the following steps:

Step 1: Search the factory system for all UPP SubSystems (UPPSSs).

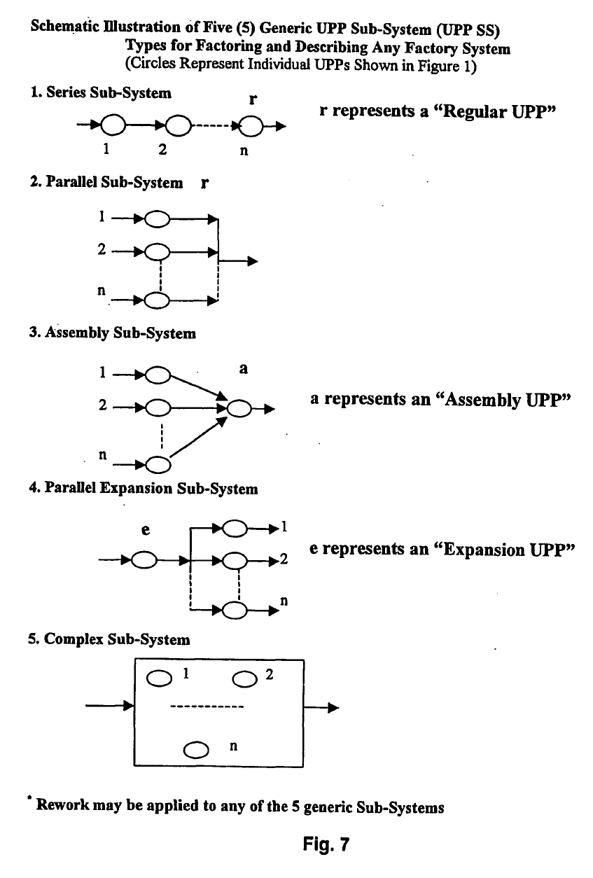

Step 2: Calculate the OTE and CTE for the identified UPPSSs using the combining and analysis rules summarized in FIGS. 8A and 8B, Table 4.

Step 3: Treat each UPPSS as a unit, analogous to a UPP, and connect them to form a new representation of the factory system.

Step 4: Repeat steps 1 to 3 until the new representation of the factory system reduces to a single unit factory (UF), thus obtaining the factory system's OTE and CTE.

This framework is applied for the application of the algorithms outlined in previous sections for calculation of throughput effectiveness, cycle time effectiveness, throughput and inventory of UPPs, UPPSSs and UFs. The next section provides examples for calculation of OEE, OTE and CTE.

11. Example Calculations: OEE, OTE and CTE

The application of the algorithms previously described for calculating OTE and CTE for UPP subsystems described as series, parallel, assembly, and parallel expansion in FIG. 7 are described herein. Parameter values used in the examples are hypothetical but realistic inputs based on data obtained for real manufacturing systems of an industrial manufacturer.

11.1. Example Metrics Calculation For Series and Parallel SubSystems

Parameter inputs in this example are for a production shift of 8 hours or 28,800 seconds.

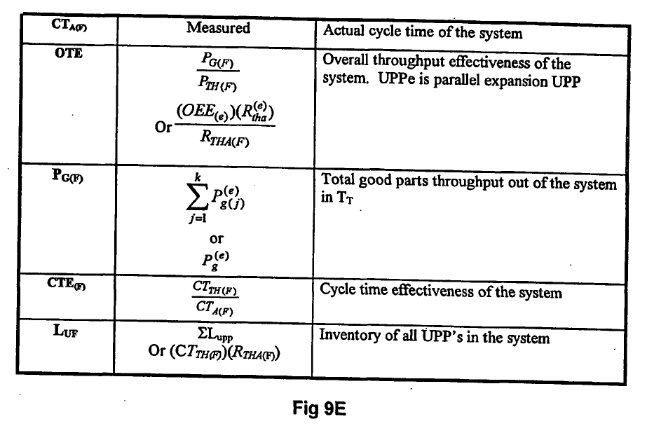

As shown in FIG. 15 the UF comprises seven UPPs interconnected either as series or parallel sub-systems. Two part types (X and Y) are produced at each UPP with different processing rates. The first three machines are connected in series with parts output from UPP III fed into either of two machines in parallel. Parts from both parallel machines are finally fed into the last UPP (V), assuming no input or output buffers and zero setup time at each UPP.

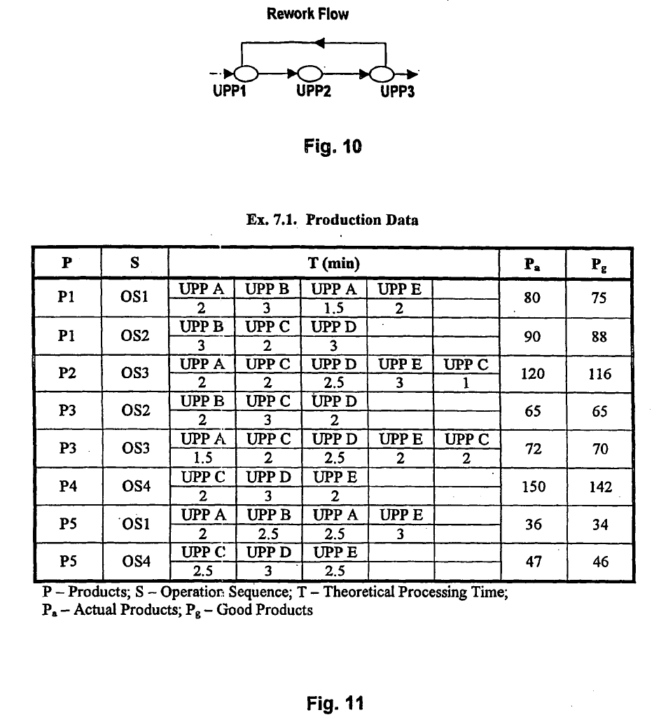

To apply the algorithms, the various UPPs is first categorized into sub-systems according to their interconnection between each other, in this case either parallel or series. Therefore, the seven UPPs become two sub-systems denoted S and P, for series and parallel respectively, connected to the single final UPP in the end (UPP V), shown in FIG. 16.

The combination rules used to combine UPPs based on their interconnections are also used to combine sub-systems or UPPs and sub-systems. According to FIG. 16 the two sub-systems S and P and the UPP (V) are connected in series. Combining these together finally provides a final result of OTE and CTE for the entire UF.

Sections 1.1 and 1.2 demonstrate calculating OTE and CTE for each sub-system and OEE for UPP V. Finally, in Section 1.3 OTE and CTE are calculated for the entire factory (UF).

11.1.1. Series-Connected UPP Sub-System

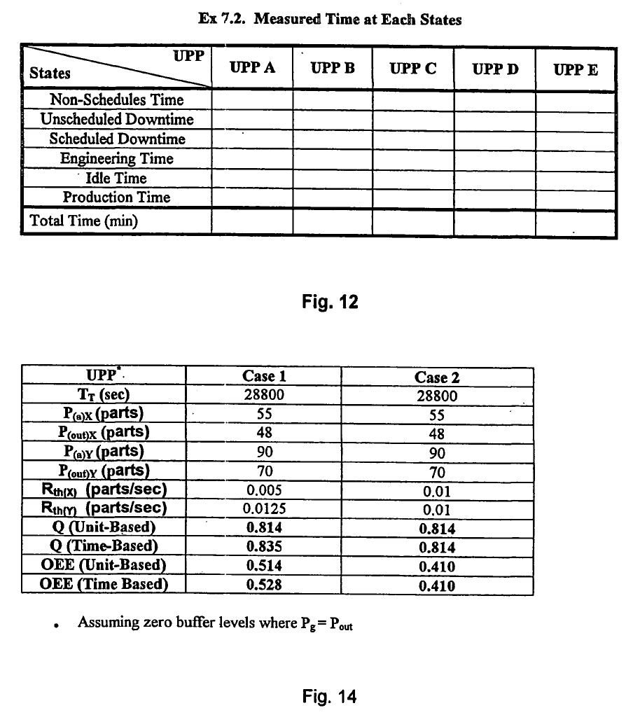

The OEE for each UPP in sub-system S is determined from the collected data using Equation (8). Before that the theoretical average processing rates Rₜₕₐ were calculated using Equation (3). Collected data and results are shown in the table in FIG. 17A.

The theoretical average processing rate for the series sub-system is determined from Equation (26) to be 0.0069 parts/sec and the total number of parts produced is 96 good parts of types X and Y. Therefore using Equation (27), OTE for sub-system S is:

OTEₛ=0.48

Using transportation times given in the table in FIG. 17B and the assumptions listed above, CT_{TH} for the series sub-system was determined from Equation (28) as 412 sec/part.

With a measured average actual cycle time (CT_{A(S)})of 500 sec/part, the CTE for the series sub-system using Equation (23) would be:

CTEₛ=0.82

11.1.2. Parallel-Connected UPP Sub-System

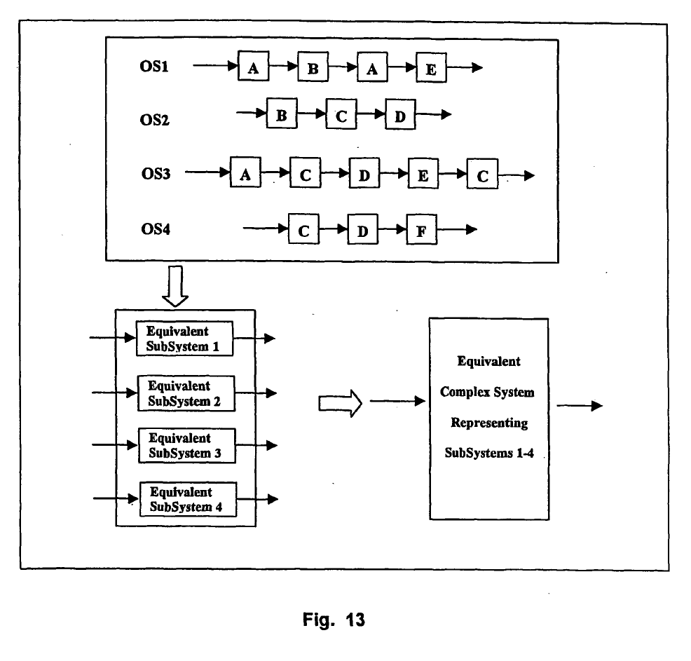

As with the series sub-system, Rₜₕₐ and OEE for each UPP were determined, as shown in the table in FIG. 18A.

From Equation (32), R_{THA(P)} is 0.009 parts/sec and Equation (33) gives,

OTE_{P}=0.33

The table in FIG. 18B lists CTth for each UPP also based on assumptions of no buffers and zero setup time. From Equation (34), CT_{TH(P)} is 225.5 sec/part.

With a measured average actual cycle time (CT_{A(P)})of 300 sec/part, the CTE for the parallel sub-system using Equation (23) is:

CTE_{P}=0.75

11.1.3. Unit Factory

The production line or factory is now represented as two sub-systems (S and P) and a UPP (V) combined in series. Applying the same algorithms used for a set of series UPPs, OTE and CTE for the UF may be calculated after determining OEE and CTₜₕ of the last UPP (V).

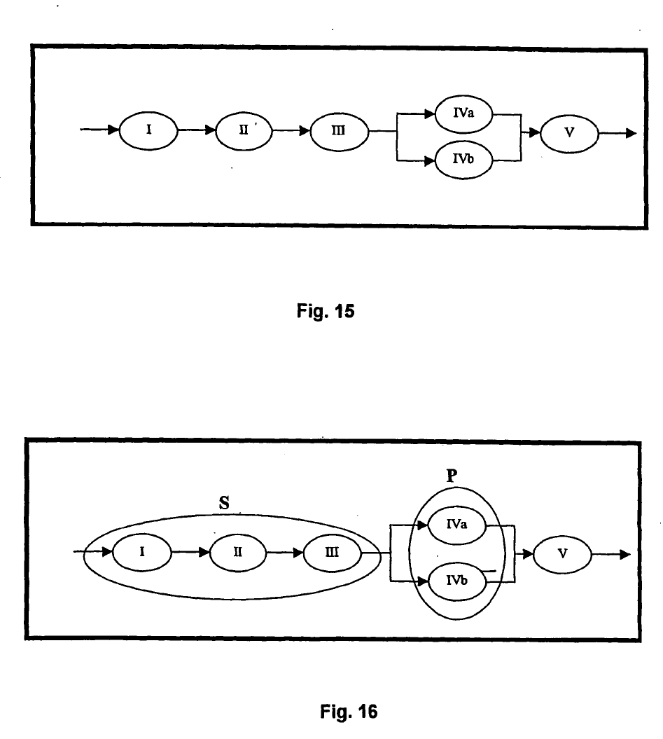

Data and calculations for the last UPP (V) are shown in the table in FIG. 19A.

CTₜₕ is also based on the same assumptions listed above with no transportation time following it. Hence using Equation (28) CT_{th(V)} is 120.5 sec/part (see the table in FIG. 19B).

With a measured average actual cycle time (CTₐ) of 160 sec/part, the CTE for the parallel sub-system using Equation (23) is:

CTE=0.75

The table in FIG. 19C summarizes results from both sub-systems and the UPP.

Again, from Equation (26) and (27):

R_{THA(F)}=0.0069 parts/sec

and,

OTE_{(F)}=0.42

Since transportation times were already included in the sub-system calculations, CT_{TH(F)} for the UF is 758 sec/part.

Finally, with an average actual cycle (CT_{A(F)}) of 960 sec/part, Equation (23) yields:

CTE_{(F)}=0.79 sec/part

11.2. Example Metrics Calculation For An Assembly Subsystem

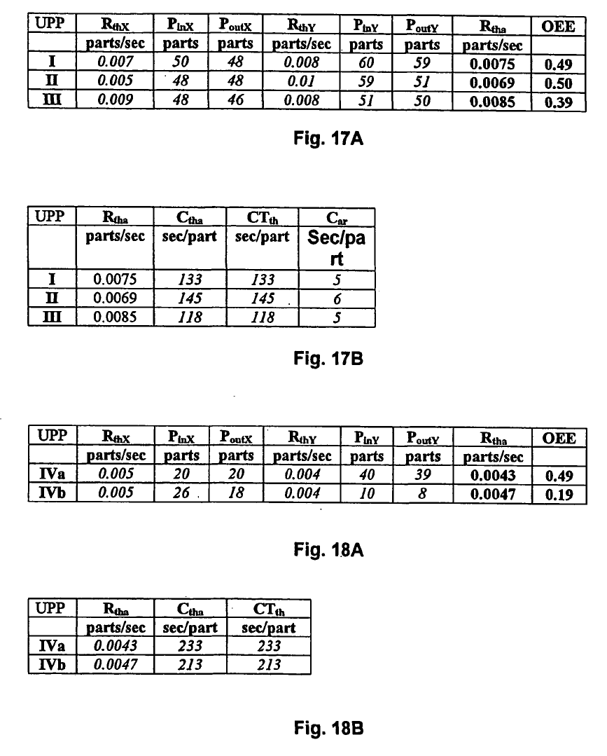

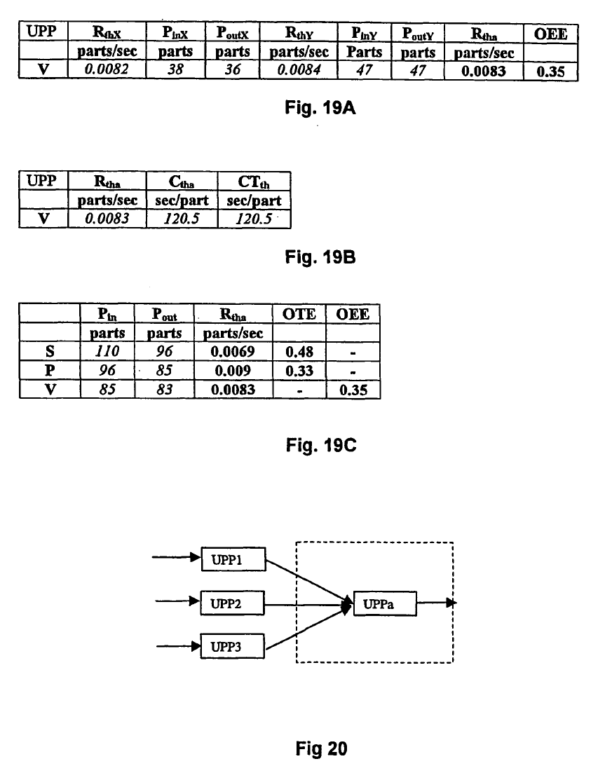

Parameter inputs in this example are for a production shift of 8 hours or 28,800 seconds, using the designations for the Assembly Subsystem as indicated below, where UPP1, UPP2 and UPP3 are “Regular UPPs”, and UPPa is an “Assembly UPP”. The example includes the processing of multiple product types. See FIGS. 20, 21A and 21B.

11.3. Example Metrics Calculation For A Expansion Subsystem

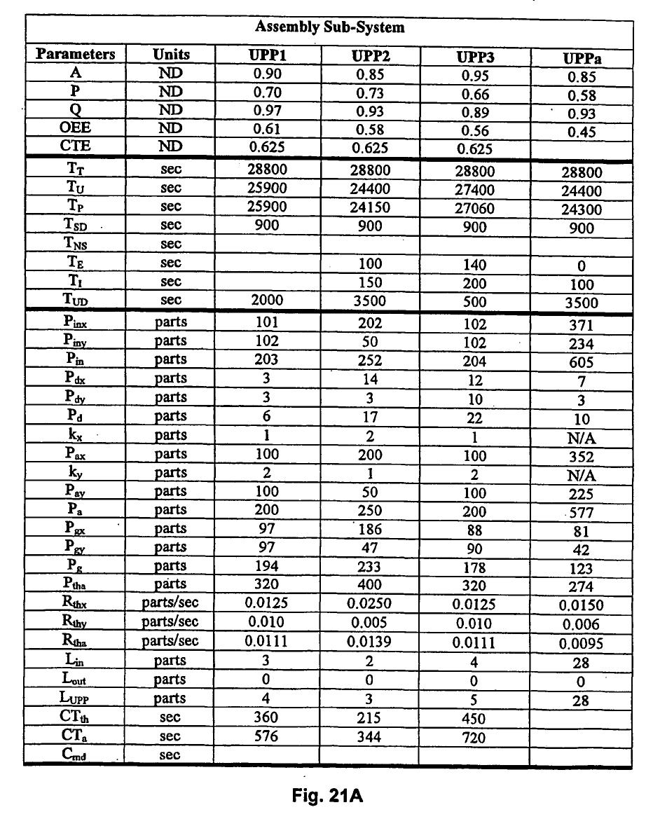

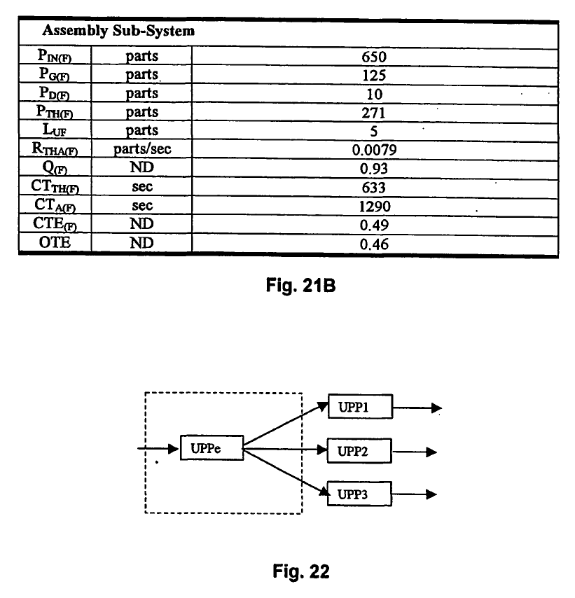

Parameter inputs in this example are for a production shift of 8 hours or 28,800 seconds, using the designations for the Expansion Subsystem as indicated below, where UPP1, UPP2 and UPP3 are “Regular UPPs”, and UPPe is an “Expansion UPP”. The example includes the processing of multiple product types. See FIGS. 22, 23A and 23B.

12. Methodology for Electronic Flow Charting and Productivity Measurement Tool

12.1. Overview of Electronic Flow Charting Productivity Measurement Tool (EFCPMT) Construction and Operation

One particular embodiment of this invention is the application of the productivity framework and algorithms for the measurement and analysis of the productivity of real factories based on factory data. One method to accomplish this is to use standard spreadsheet tools (e.g. EXCEL or other suitable tools) to conduct the calculations based on the factory flowchart and UPP and UPPSS algorithms. A second method is the use of a novel visual flowcharting and measurement tool with the manufacturing framework and the algorithms for productivity measurement at the equipment, subsystem and factory level coded in a standard computer language (e.g. Visual Basic or other suitable languages).

An Electronic Flow Charting Productivity Measurement Tool (EFCPMT) has been developed by using Microsoft™ Visual Basic 6.0 to measure and analyze manufacturing system productivity based on the developed manufacturing productivity metrics at Unit Production Process (UPP) level, UPP Sub-System (UPPSS) level and Factory System or Unit Factory (UF) level. Major functions of this software tool include 1) electronic flowcharting of the manufacturing system, 2) production data acquisition or input, 3) manufacturing productivity calculation, and 4) export of manufacturing productivity metrics and information (e.g. EXCEL or other spreadsheets).

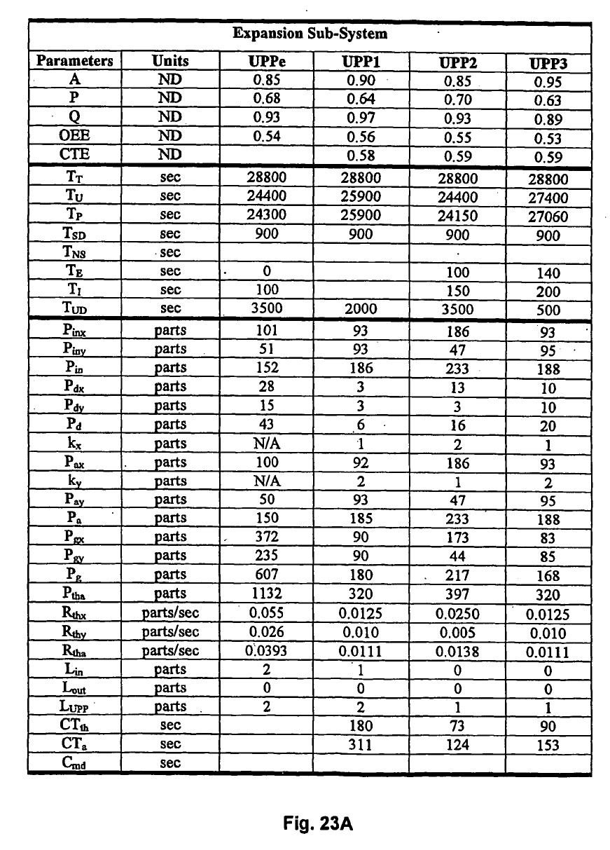

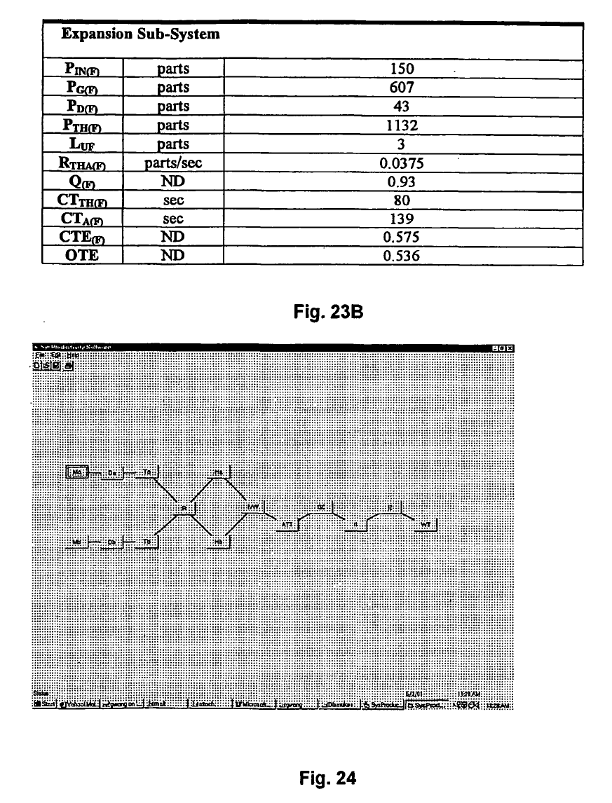

The first step is to create an electronic flowchart of the manufacturing flowchart in the EFCPMT, which incorporates all the parameter definitions of Tables 1-3 (FIGS. 2A-2B, 3 and 9A-9E) and the connection and analysis rules of Table 4 (FIGS. 8A and 8B). FIG. 24 illustrates an electronic flowchart generated by the EFCPMT for a manufacturing system of 15 UPPs. The next step after flowcharting the system is to enter the appropriate production parameters. This is implemented by individual entry of the data, or by interfacing with the Raw Data sheet in EXCEL file by using Visual Basic Application (VBA). Productivity metrics at UPP level, subsystem level and production system or factory level are then calculated, and a bar chart for OEE, OTE and CTE can be generated for system analysis as illustrated in FIG. 25. The results are written into a different sheet in EXCEL or a different table in other databases. The interfacing task is implemented by VBA. Data outputs can also be used as inputs for automatic creation of simulation models discussed in a following section.

12.2. Linkage Rules and Algorithms For UPP Interconnection and Algorithms for UPP SubSystem Recognition

For general application, UPPs are characterized in three categories: Regular, Assembly and Expansion. For a Regular UPP, used in Series and Parallel Subsystems, the input and output units of material flow are equal. For an Assembly UPP, the output units of material flow are a factor of 1/N times the input units, representing the assembly process. For an Expansion UPP, the output units of material flow are a factor of N times the input units, representing the expansion process.

The interconnectivity of a manufacturing system, visualized as a flow chart, is represented as a directed graph in the electronic flowcharting and productivity measurement tool (EFCPMT). Details of the representation is as follows:

A UPP i is represented as a vertex Vᵢ, where i=1, 2, . . . , n, n is the number of UPP in the manufacturing system

If parts flow from UPP i to UPP j, then there is a directed edge from Vᵢ to Vⱼ

Vertex Vᵢ, representing UPP i, has a property called type, which can be regular (R), assembly (A), or expansion (E).

A starting vertex V₀ and an ending vertex Vₙ₊₁, representing warehouses for the incoming materials and the outgoing products, respectively, are added. Both vertices are of type R. In other words, they are treated as regular UPPs.

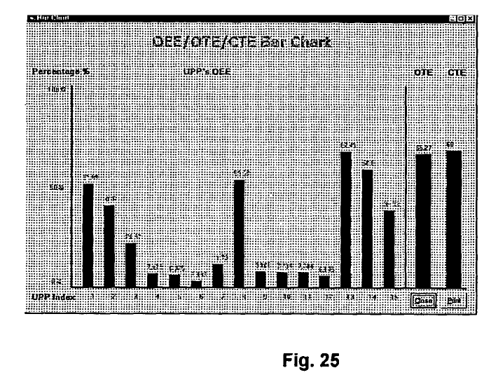

An algorithm, based on graph theory, has been developed to automatically recognize UPP subsystems for the EFCPMT, as shown in FIG. 26. Details of the two top left side boxes in FIG. 26 are public knowledge in the graph theory literature, and hence, are not explained further. The type of merged vertices is always regular. The following is an example illustrating how the algorithm works.

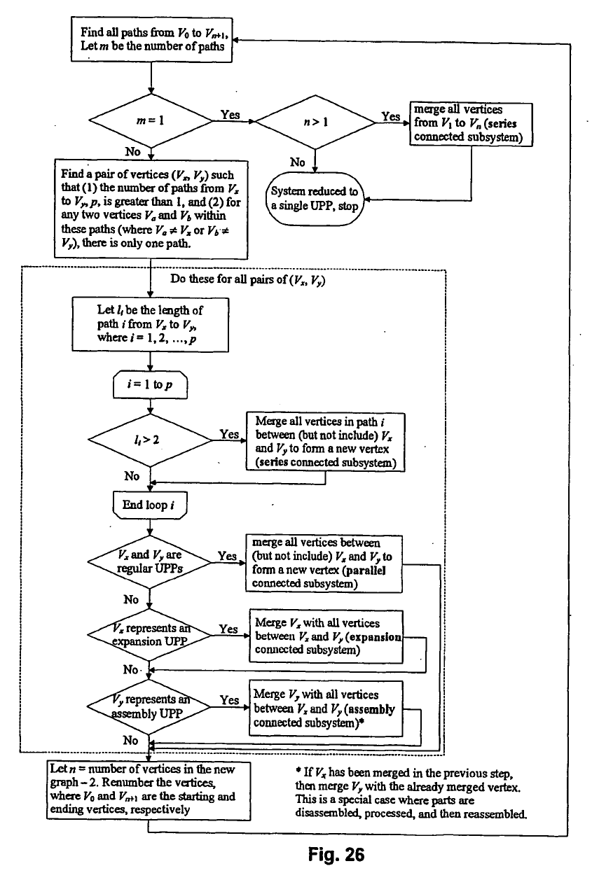

FIG. 27 shows the example manufacturing system and its corresponding graph representation. There are four paths from V₀ to V₁₁, listed as follows:

1. V₀→V₁→V₄→V₇→V₉→V₁₀→V₁₁

2. V₀→V₁→V₅→V₈→V₉→V₁₀→V₁₁

3. V₀→V₂→V₆→V₁₀→V₁₁

4. V₀→V₅→V₆→V₁₀→V₁₁

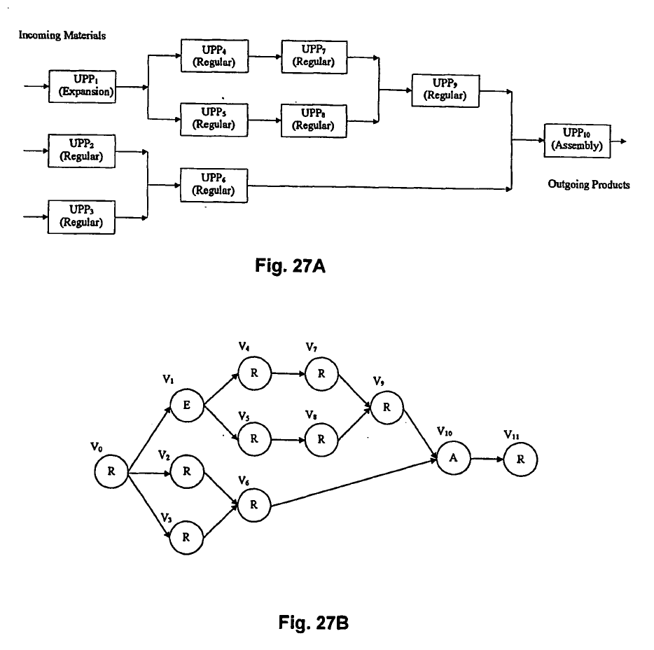

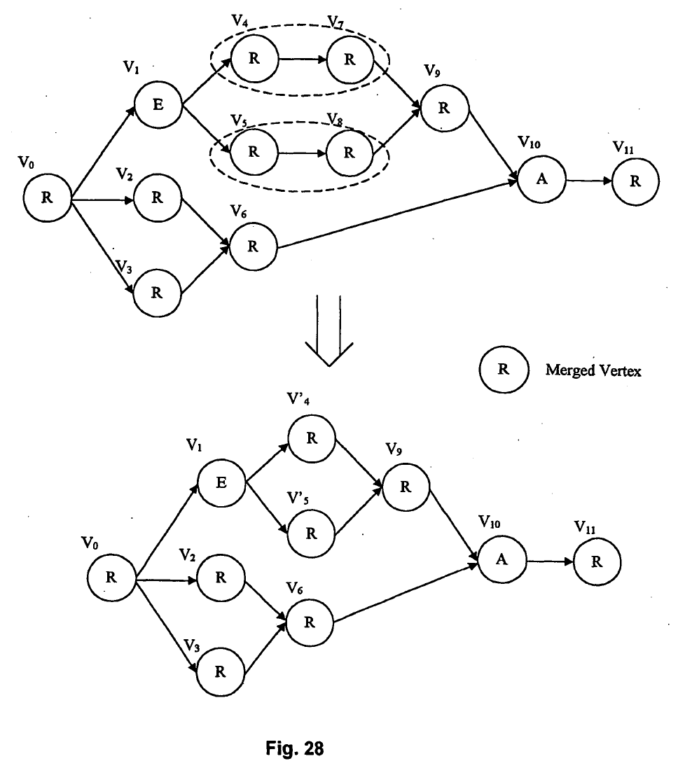

Therefore, the number of paths, m, is 4. Thus, the pairs of (Vₓ, V_{y}) must be found. There are two such pairs, (V₁, V₉) and (V₀, V₆). Consider the pair (V₁, V₉) first p=2; since there are two paths from V₁ to V₉, namely, V₁→V₄→V₇→V₉ and V₁→V₅→V₈→V₉. I₁=I₂=3, since there are three edges in both paths. Therefore, V₄ and V₇ form a series connected subsystem, while V₅ and V₈ form another. V₄ is merged with V₇ to form a new vertex V′₄, and V₅ is merged with V₈ to form another new vertex V′₅, as shown in FIG. 28. Since V₁ is an expansion UPP, it forms an expansion connected subsystem with V′₄ and V′₅. These three vertices are merged to form a new vertex V′₁, as shown in FIG. 29.

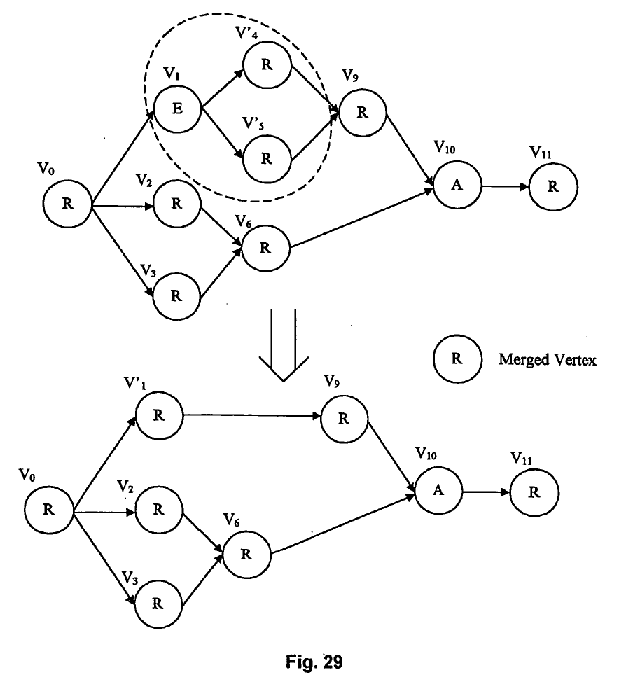

Now consider the pair (V₀, V₆). p=2, since there are two paths from V₀ to V₆, namely, V₀→V₂→V₆ and V₀→V₃→V₆. I₁=I₂=2, since there are two edges in both paths. Since both V₀ and V₆ are regular UPPs, V₂ and V₃ form a parallel connected subsystem. They are merged to form a new vertex V₂, as shown in FIG. 30.

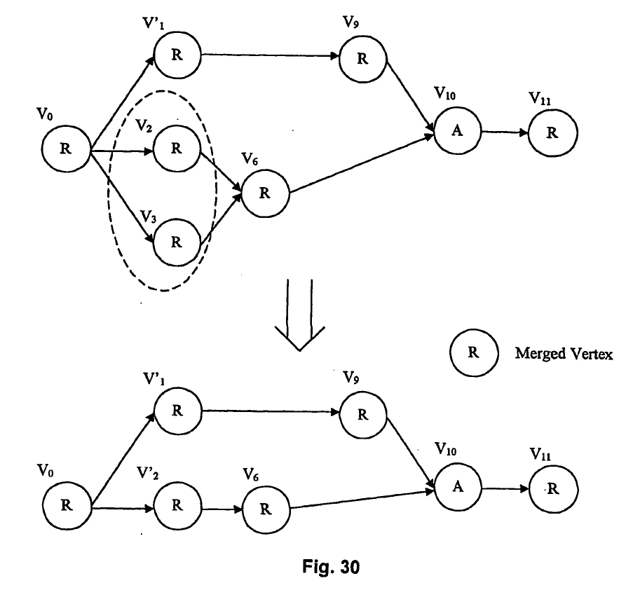

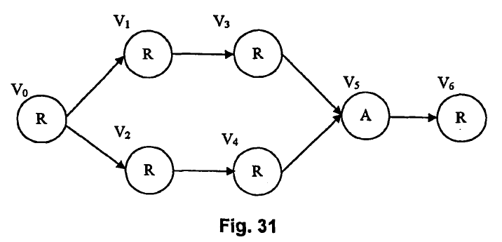

There are now 7 vertices in the new graph. Therefore, n=7−2=5. Renumber vertices of the graph as shown in FIG. 31, where V₀ is still the starting vertex and V₆ is the ending vertex. This time there are two paths from V₀ to V₆. One pair of (Vₓ, V_{y}) is found, namely, (V₀, V₅). p=2, since there are two paths from V₀ to V₅. I₁=I₂=3. Therefore, V₁ and V₃ form a series connected subsystem, while V₂ and V₄ form another. Since V₅ is an assembly UPP. The newly merged vertices V′₁ and V′₂ are merged with V₅ since they form an assembly connected subsystem. These steps are illustrated in FIG. 32. There are now 3 vertices in the new graph. Therefore, n=3−2=1, and there is only one path from the starting vertex to the ending vertex. This means the whole system has been reduced to a single UPP. The procedure terminates.

13. Methodology for Automated Simulation Model Building for Rapid What-if Scenario Analysis

The electronic flowcharting and productivity measurement tool (EFCPMT) provides a way to analyze an existing production facility (manufacturing system). When changes (introduction of new equipment, change of scheduling policy, etc.) are needed, it is desirable to evaluate the effect of these changes on productivity before they are actually implemented. This “what-if” scenario analysis is usually carried out through discrete event simulation, which allows a manufacturing company to implement the best changes, thus “do things right the first time.”

While there are a number of commercially available software tool for discrete event simulation, building a simulation model requires substantial experience and is time consuming. However, one aspect of the present invention provides a method to automatically build a simulation model from the electronic flowcharting and productivity measurement tool, based on the captured production data and the structure (connectivity) of the production facility.

In another aspect, the dynamic simulation is then linked to market demand. To illustrate how this methodology works, the following example uses the ARENA simulation software tool, developed by Rockwell Software Inc., to represent the simulation environment. However, the method can be generally applied to other simulation software tools.

ARENA has the capability of import/export a simulation model from an external database such as Microsoft EXCEL and ACCESS. Each model database divides its model data into separate storage containers called tables (worksheets in EXCEL). These tables organize the data into columns (called fields) and rows (called records). The model information that may be stored in a model database includes the following:

Modules (including coordinates and data) from any panel

Submodels (including coordinates and properties)

Connections between modules and submodels

Named views

Project parameters, replication parameters, and report parameters specified in Arena's Run/Setup option

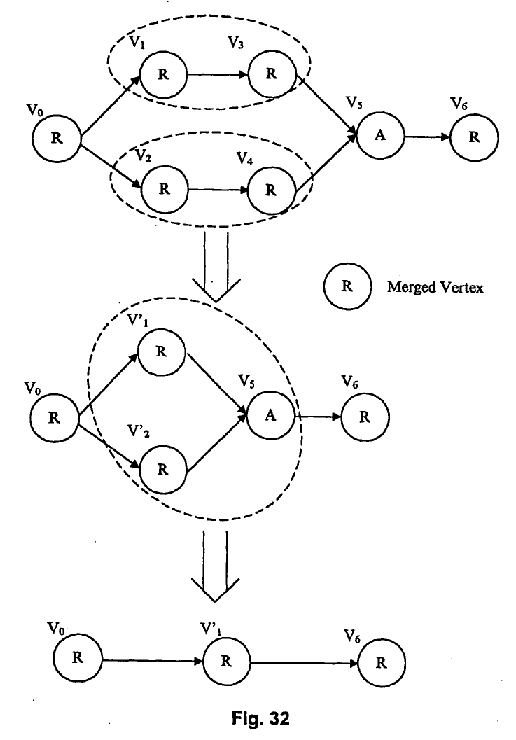

The electronic flowcharting and productivity measurement tool can automatically generate all of the information and stored them in ARENA required format. FIG. 33 shows an example flowchart with production-information. Note that there are two part types (with different processing time at the Trimmer) and three process stations. Therefore, the following ARENA modules are generated

Two CREATE module to simulate the arrival of part A and B

Two ASSIGN module to assign different processing time at the Trimmer

Three PROCESS module to represent the three process stations

Two ENTITY module to represent part A and B

Three RESOURCE modules, one for each PROCESS module in order to collect process utilization statistics

Three QUEUE modules, one for each PROCESS modules to determine the scheduling policy and collect queuing statistics

One DISPOSE module to represent the end point of simulation

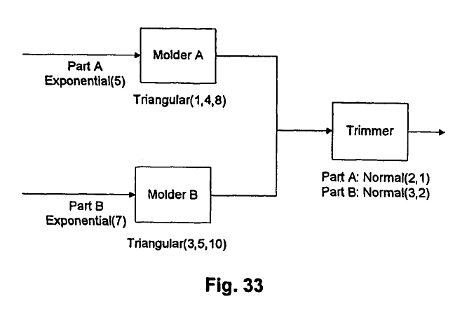

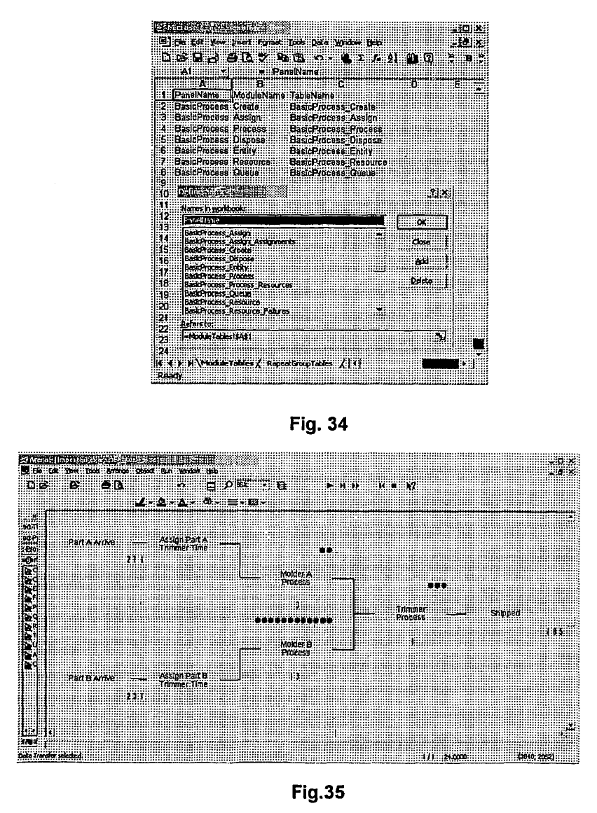

These modules, along with the connectivity information and simulation parameters (the length of simulation time, animation speed, etc.) are created in an EXCEL data file as shown in FIG. 34. This file is then imported to ARENA to automatically obtain the simulation model shown in FIG. 35. By a single mouse click, the simulation will proceed to see the effect on productivity.

14. Industrial Applicability

The present invention finds utility in businesses and industries requiring the quantitative measurement and analysis of data describing the processing or manufacture of products in production systems, including product lines, factories and supply chains. Real time productivity assessment of manufacturing operations from the equipment level to the production system level are of increasing importance to companies striving to improve and optimize performance and cost for worldwide competitiveness. In one aspect of this invention there is development of systematic metrics and methodologies for calculation, analysis and rapid simulation of equipment and system performance, based on processing multiple product types or single product types, using unit based OEE as the basis for productivity definition.

Productivity analysis at the equipment level follows from the concept (FIG. 5) of a Unit Production Process (UPP), which includes a unit process step, input and output buffers, and product flow to and out of the unit process step. Four performance metrics from the UPP analysis methodology provide useful information on productivity. The first of these is Overall Equipment Effectiveness (OEE), which represents the actual versus ideal equipment performance. The general definition reflects the six major losses from the TPM paradigram, described as the product of: availability efficiency, performance efficiency and quality efficiency, which reduces to:

$$\begin{matrix}OEE = [ \frac{{T}_{U}}{{T}_{T}} ] [ \frac{\sum {P}_{a}}{{R}_{tha} {T}_{U}} ] [ \frac{\sum {P}_{g}}{\sum {P}_{a}} ] \\ = \frac{\sum {P}_{g}}{( {R}_{tha} ) ( {T}_{T} )} \\ = \frac{{P}_{g}}{{P}_{tha}}\end{matrix}$$

Two general definitions of OEE are recognized, unit-based OEE and time-based OEE, which differ solely in the definition of the quality efficiency, and are mathematically related by the expression:

$$\frac{OEE ( Unit Based )}{OEE ( Time Based )} = \frac{{R}_{thg}}{{R}_{tha}} .$$

The unit-based OEE definition is used as one preferred embodiment, because OEE is based on exact material balance (e.g. input=output+scrap) of materials and components being processed, and hence provides a sound basis for defining and quantifying system level as well as equipment level productivity metrics. This is not generally the case for time based OEE, which adopts the forced definition of quality or yield as a time ratio based on industrial engineering preferences for analysis of production in terms of time parameters.

The second equipment performance metric is the output of good product, which is a function of the OEE and theoretical processing rate, during a fixed total time (T_{T}),

P_{g}=(OEE)(Rₜₕₐ)(T_{T}).

The third equipment performance metric is the Cycle Time Effectiveness (CTE), which is the ratio of theoretical to actual cycle time for processing a unit of product through the UPP,

$$CTE = \frac{{CT}_{th}}{{CT}_{a}} .$$

The fourth performance metric at the equipment level is the equipment level inventory or work in process,

L_{UPP}=L_{IN}+L_{UPS}+L_{OUT},

which is useful in calculating the business metric of inventory turns, P_{g}/L_{UPP}.

These four equipment level metrics provide a quantitative measurement of the 1) equipment effectiveness, 2) good product output in a measured total time, 3) the cycle time effectiveness for processing one or a group of parts through the UPP, and 4) the effectiveness of handling work-in-process inventory at the equipment level. Thus, they provide a basis for conducting root cause analysis to understand various manufacturing productivity problems and for making productivity improvements for equipment.

Productivity analysis at the production system or factory level follows from the concept (FIG. 6) of a system, i.e., Unit Factory (UF), based on a specific architectural arrangement of UPPs making up the manufacturing system.

Thus, in one aspect of the invention relates to the development and application of the novel topological concept that any system (UF) can be factored into a unique set of interconnected UPP sub-systems, primarily the “series”, “parallel”, “assembly”, “expansion” and “complex” configurations shown schematically in FIG. 7, with the provision for “rework” as illustrated for the “series” configuration in FIG. 10. To analyze the productivity of a real system, therefore, first calculate productivity metrics for each UPP and each UPP subsystem of which the overall system is composed. Then, combine the various sub-systems according to the overall manufacturing system architecture, and apply the appropriate algorithms to calculate the overall productivity of the system. These four basic performance metrics from the system level analysis methodology provide useful information on system productivity. The first of these is Overall Throughput Effectiveness (OTE), which represents the actual versus ideal system or factory performance,

$$\begin{matrix}OTE = \frac{{P}_{G ( F )}}{{P}_{TH ( F )}} \\ = \frac{Good Product Output ( Units ) from System ( Factory )}{\begin{matrix}Theoretical Actual Product Output ( Units ) \\ from System ( Factory ) in Total Time\end{matrix}}\end{matrix}$$

The second system level metric is total output of good product from the factory, which is a function of the OTE and system theoretical processing rate, during a total time (T_{T}),

P_{G(F)}=(OTE_{F})(R_{THA(F)})(T_{T})

The third system level metric is the Cycle Time Effectiveness (CTE_{(F)}), which is the ratio of theoretical to actual cycle time for processing a unit of product through the UF,

$$\begin{matrix}{CTE}_{( F )} = \frac{{CT}_{TH ( F )}}{{CT}_{A ( F )}} \\ = \frac{Theoretical Cycle T ime of System ( Factory )}{Actual Cycle Time of System ( Factory )}\end{matrix}$$

The fourth performance metric at the system level is the system or factory level inventory or work in process,

L_{UF}32 Σ_{LUPP},

which is useful in calculating the business metric of inventory turns for the factory, P_{G(F)}/L_{UF}, or P_{G(F)}/Σ(L_{UPP}).

These four metrics provide quantitative measurement of: 1) overall throughput effectiveness, 2) good product output in a measured total time, 3) cycle time effectiveness for processing single or multiple product types through the Unit Factory (UF), and 4) the effectiveness of handling work in process inventory at the system level. This overall assessment provides understanding of dynamics of production and of the various loss factors at the system level in terms of the OEE and other parameters at the UPP level, the UPP sub-systems used to factor the system, and the overall UPP arrangements (architecture) of the system.

The productivity metrics presented are used to measure the effectiveness of a manufacturing system in terms of productivity, and are also used to identify opportunities for productivity improvement and optimization.

One example for applying these metrics to achieve manufacturing excellence for an existing production facility (manufacturing system) is described as follows. Mechanisms (data collection and analysis) are set up to measure equipment as well as factory level productivity metrics and inventory levels. In a steady state production environment, lower and upper bounds are established for these metrics where they are “in control,” i.e., productivity is fluctuating within an allowable range as determined by the company either through rigorous mathematical analysis or heuristic best practices. When any productivity metric is out of control, the problem UPP and UPP subsystem is quickly identified. A analysis of the problem cause allows steps to be taken to rectify the problem. In the event that changes in the production facility are desirable, e.g., the addition of new machines or change of scheduling policy, simulation is then rapidly carried out to evaluate their effects on productivity. The scenario that results in the highest OTE and CTE should be implemented. This will allow a manufacturing company to achieve the goal of “do things right the first time”.

In another aspect of the present invention, the method is useful for other applications through combining analysis at the UPP level with that of the UPP subsystem level, and at the system level, and by further extending it to the supply chain, which includes transportation links between factories. At the UPP level, contributions are made to improving the new product development and technology transfer process 1) by expressing the rate (or cycle time) parameters of OEE and CTE as functions of the underlying science and the engineering dynamics of the UPP, based on its configuration and applicable physical laws including heat and mass transfer, and 2) by incorporating costs on an “activity based costing” basis at each UPP activity center. This provides insight into the ultimate potential of particular UPP's as they progress from the discovery stage to eventual maturity. At the production system or factory level, systematic analysis of the relationships between individual UPP productivity, UPP sub-system productivity, and overall system productivity can be expected to yield design rules for factory and supply claim optimization as a function of overall architecture.

The method of the present invention provides understanding of the production dynamics of each UPP, each UPP sub-system, and of the overall system. The assessment identifies the various loss factors at the factory level in terms of the OEE and other parameters at the UPP level, the UPP sub-systems of which the system is composed, and of the overall production system architecture, including processing and transportation steps. Therefore, the method provides insight and guidance essential for making near term improvements or long-term optimization of the performance of complex production systems.

While the present invention has been particularly been described with reference to the embodiments described herein, it should be readily understood to those of ordinary skill in the art that changes and modifications in form and detail can be made without departing form the spirit and scope of the invention. For example, the methods described above may be implemented in software including different languages. Also any suitable hardware may be used.

The following references are fully incorporated herein by reference.

### REFERENCES

1. Seiichi Nakajima, “Introduction to TPM: Total Productive Maintenance,” Productivity Press, Portland, Ore., pp. 7-49, 1988

2. Nachi-Fujikoshi, “Training for TPM: A Manufacturing Success Story,” Productivity Press, Cambridge, Mass., pp. 5-31, 1990.

3. Edward H. Hartmann, “Successfully Installing TPM in a Non-Japanese Plant: Total Productive Maintenance”, TPM Press, Inc., Allison Park, Pa., 1992.

4. Tokutaro Suzuki, “TPM in Process Industries,” Productivity Press, Portland, Ore., pp. 21- 44, 1994.

5. Charles J. Robinson, Andrew P. Ginder, “Implementing TPM: The North American Experience,” Productivity Press, Portland, Ore., pp. 125-149, 1995.

6. JIPM, “TPM-Total Productive Maintenance Encyclopedia,” JIPM, Atlanta, Ga., 1996.

7. K. E. McKone, R. G. Schroeder, and K. O. Cua, “Total Productive Maintenance: A Contextual View”, Journal of Operations Management, Vol. 17, Issue 2, pp. 123-144 (1999).

8. V. A. Ames, Jerry Gililland, John Konopka, and Rich Schnabl, SEMATECH; Kevin Barber, Rockwell, “Semiconductor Manufacturing Productivity, Overall Equipment Effectiveness (OEE) Guidebook,” SEMATECH Revision 1.0, Technology Transfer 95032745A-GEN, Apr. 13, 1995.

9. John M. Konopka, “Improvement Output in Semiconductor Manufacturing Environments,” PhD Thesis, Arizona State University, Tempe, Ariz., 1996.

10. D'Elia, Michael J. Alfonso, Ted F, “Optimizing process and equipment efficiency using integrated methods,” Process, Equipment, and Materials Control in Integrated Circuit Manufacturing II, Austin, Tex., USA, pp. 125-134, Oct. 16-17, 1996.

11. Giegling, S., Verdini, W. A., Haymon, T., and Konopka, J. M., “Implementation of Overall Equipment Effectiveness (OEE) System at a Semiconductor Manufacturer,” Proceedings of 1997 IEMT Symposium, Austin, Tex., USA, pp. 93-8,1997.

12. Ziemerink, Richard A. and Bodenstein, Charles P., “Utilizing a LonWorks control network for factory communication to improve overall equipment effectiveness”, Proceedings of the 1998 IEEE International Symposium on Industrial Electronics ISIE. Part 2 (of 2), Pretoria, S Africa, pp. 684-689, Jul. 7-10, 1998.

13. R. C., Leachman. “Closed-Loop Measurement of Equipment Efficiency and Equipment Capacity”, IEEE Transactions on Semiconductor Manufacturing, Vol. 10, No.1, February 1997, pp. 84-97.

14. International SEMATECH, “Standard For Definition And Measurement of Equipment Productivity,” SEMI E79-299 (Draft), 1999.

15. J. Bonal, C. Ortega, L. Rios, S. Aparicio, M. Fernandez, M. Rosendo, A. Sanchez and S. Malvar, “Overall Fab Efficiency,” Proceedings of the 1996 ₇th Annual IEEE/SEMI Advanced Semiconductor Manufacturing Conference, ASMC 96, Cambridge, Mass., USA, pp. 49-52, Nov. 12-14, 1996

16. A. Slettehaugh and A. London, “Impact Of Lot Buffering On Overall Equipment Effectiveness”, Semiconductor International, Vol. 21(8), pp. 153-160 (1998).

17. Dismukes, J. P., Vonderembse, M. A., S. Chandrasekaran, Bennett, R. J., Chen, F. F., Gerhardinger, P. F., Okkerse, R. F., and Caldwell, W. P., “University-Industry Collaboration For Radical Innovation in Flat Glass Manufacturing,” Proceedings of the PICMET'99 Conference, Portland, Ore., Jul. 25-29, 1999.

18. Chandrasekaran S., “Productivity Analysis in Flat Glass Manufacturing,” MS Thesis, The University of Toledo, December, 1999.

19. Dismukes, J. P., Vonderembse, M. A., S. Chandrasekaran, Hudspeth, Lonnie, and Caldwell, W. P., “Opportunities For Radical Innovation in Flat Glass Production Operations,” Proceedings of the 60^{th} Conference on Glass Problems, Oct. 19-20, 1999.

20. Ge Wang, John P. Dismukes, Samuel H. Huang and Sriram Chandrasekaran, Manufacturing Productivity Assessment Using Overall Equipment Effectiveness (OEE), Proceedings of the 2000 Japan-USA Symposium on Flexible Automation, Jul. 23-26, 2000.

21. “OEE For Operators”, Productivity Inc., 541 NE 20th Street, Portland, Ore. 97232, www.ppress.com

22. “OEE Toolkit”, A Software Package from Productivity Inc., 541 NE 20^{th} Street, Portland, Ore. 97232, www.ppress.com

23. “EASI OEE”, A Software Package from IPC Fab Automation GmbH, Kreuzbergweg 1a, 93133 Burglengenfeld, Germany, www.ipc-fabautomation.com

24. “Scoope Project”, A Software Package from ABB, Hoge Wei 27, B-1930 Zaventem, Belgium, www.scoope.com

25. A. Cheng-Leong, K. L. Pheng, and G. R. K. Leng, “IDEF*: A Comprehensive Modelling Methodology for the Development of Manufacturing Enterprise Systems”, International Journal of Production Research, Vol. 37, pp. 3839-3858 (1999).

26. F. Mason, “Mapping a Better Process”, Management Engineering, pp. 58-68, April 1997.

27. J. L. Burbidge, “Production Control: A Universal Conceptual Framework,” Production Planning and Control, Vol. 1(1), 3-16, 1990.

28. J. L. Burbidge, “Change to Group Technology: Process Organization is Obsolete”, Int. J. of Production Research, Vol. 30, n. 5, p. 1209-1219 (1992)

29. J. L. Burbidge, “The Use of Period Batch Control (PBC) in the Implosive Industries,” Production Planning and Control, Vol. 5(1), 97-102, 1994.

30. D. J. Miller, The Role of Simulation in Semiconductor Logistics”, Proceedings of the 1994 Winter Simulation Conference, pp. 885-891 (1994).

31. D. Kayton, T. Teyner, C. Schwartz, and R. Uzsoy, “Focusing Maintenance Improvement Efforts in a Wafer Fabrication Facility Operating Under The Theory of Constraints”, Production and Inventory Management Journal, 4^{th} Quarter 1997, pp. 51-61.

32. H. William Dettner, “Goldratt's Theory of Constraints”, ASQC Quality Press, Milwaukee, 1997.

33. D. P. Martin, The Advantages of Using Short Cycle Time Manufacturing (SCM) Instead of Continuous Flow Manufacturing (CFM), IEEE/SEMI Advanced Semiconductor Manufacturing Conference, pp. 4349 (1998).

34. O. Ruelle, Continuous Flow Manufacturing: The Ultimate Theory of Constraints, IEEE/SEMI Advanced Semiconductor Manufacturing Conference, pp. 216-221 (1997).

35. D. Scott and R. Pisa, “Can Overall Factory Effectiveness Prolong Moore's Law?”, Solid State Technology, pp. 75-82 (1998).

36. D. Scott, “Can CIM Improve Overall Factory Effectiveness?”, Pan Pacific Microelectronics Symposium, Proceedings of the Technical Program, Hawaii, Feb. 2-5, 1999

We claim:

1. A hierarchical method for causally relating productivity to a production system to provide an integrated productivity analysis of the system, comprising:
a) identifying an array of production operations including any one or more of the following: process, transportation and storage;
b) modeling the system as an interconnected array of unit production processes (UPP) reflecting actual or desired material flow sequence through the system;
c) applying at least one set of UPP interconnections to factor the system into at least one set of UPP subsystems for description and analysis; and
d) assessing each UPP and each subsystem to calculate at least one productivity metric of each UPP, UPP subsystem and the system.

2. The method of claim 1, in which the UPP subsystems include any one or more of the following: series, parallel, assembly, expansion, and complex, with rework modes applicable to each.

3. The method of claim 2, in which each UPP comprises input transport rates from an upstream UPP, and output transport rates to a downstream UPP, input and output storage buffers for work in process, and a unit process step.

4. The method of claim 1, in which algorithms are applied to calculate the productivity metrics of unit based overall equipment effectiveness (OEE), cycle time effectiveness (CTE), production throughput of good product (P_{g}) and UPP inventory level (Lᵤₚₚ), based on any one or more of the following: factory data for equipment time parameters, theoretical cycle time, actual cycle time, arrival and departure rates, and input and output buffer levels.

5. The method of claim 1, in which algorithms are applied to calculate UPP subsystem and/or system level productivity metrics of overall throughput effectiveness (OTE_{F}), cycle time effectiveness (CTE_{F}), production throughput of good product (P_{G(F)}) and UPP subsystem or factory inventory level (L_{F}), based on factory data and the productivity metrics for each UPP.

6. The method of claim 1, in which measurement, monitoring and quantitative calculation of the productivity metrics for the UPPs, the UPP subsystems, and/or production system is conducted using spreadsheet analysis tools which represent an actual factory architecture or the system.

7. The method of claim 6, in which measurement, monitoring and quantitative calculation of the productivity metrics for the UPPs, the UPP subsystems, and systems is conducted using a flowchart tool and a graphical user interface for data input and metrics output in appropriate spreadsheet or chart format.

8. The method of claim 7, comprising:
creating UPPs required to represent the generic subsystem types,
creating data input and metrics output boxes for standard input and output of data and results,
linking the UPPs to represent the experimental material flow sequence, or system architecture, with recognition algorithms applied to identify generic subsystem types, and
calculating productivity metrics for each UPP, UPP subsystem, and the overall system.

9. The method of claim 8, in which the UPPs include regular, assembly and expansion.

10. The method of claim 1, further comprising building an automated simulation model comprising importing data in spreadsheet form from a flowcharting and measurement tool, and representing interconnectivity of the system and actual and theoretical performance characteristics.

11. The method of claim 10, in which the simulation model comprises a rapid what-if scenario analysis of existing production facilities or systems, wherein specific changes needed for bottleneck removal and productivity improvement are identified.

12. The method of claim 11, in which the scenario analysis is linked to market demand.

13. The method of claim 11, in which the simulation model comprises rapid assessment and development of new factory designs optimized for specific manufacturing performance.

14. The method of claim 1, wherein the UPP includes any one or more of the following: equipment, subsystem, product line, factory, transportation system, and supply chain (which includes transportation-systems and manufacturing systems).

15. The method of claim 1, wherein measurement and analysis of the system are conducted using a spreadsheet analysis and a visual flowcharting and measurement tool coded with the algorithms for unit-based productivity measurement at the equipment, subsystem and system level.

16. The method of claim 15, wherein the measurement and analysis of the system is conducted for single and/or multiple product types.

17. The method of claim 15, wherein data representing interconnectivity of the system and intrinsic performance characteristics are transferred from the flowcharting and measurement tool via at least one or more spreadsheets to set up an equivalent manufacturing array in a discrete event simulation software package.

18. The method of claim 17, wherein development and implementation of a dynamic simulation is used to assess scenarios for eliminating bottlenecks and tailoring performance, and to develop new designs optimized for specific requirements in the production system.

19. The method of claim 17, wherein the production system includes any one or more of the following: equipment, subsystem, product line, manufacturing process, factory, transportation system, and supply chains (which includes transportation systems and manufacturing systems).

20. The method of claim 1, wherein the method is used to analyze overall equipment effectiveness.

21. A method for hierarchical representation of a production system for measuring, monitoring, analyzing and/or simulating production performance of the production system based on a common set of productivity metrics for throughput effectiveness, cycle time effectiveness, throughput and inventory, comprising:
a) identifying an array of production operations including any one or more of the following: process, transportation, and storage;
b) providing a description of the production system as an interconnected array of unit production processes (UPP) reflecting an actual material flow sequence through the system;
c) applying at least one set of UPP subsystems to factor an overall system flowchart into UPP subsystems, and combining the subsystems to represent the overall production system;
d) analyzing productivity metrics of each UPP, each UPP subsystem, and the overall system; and
e) converting the overall system flowchart to a discrete event simulation description, and enabling comparative performance assessment of various production scenarios useful for performance improvement and system design.

22. The method of claim 21, in which the UPP subsystems include any one or more of the following: series, parallel, assembly, expansion, and complex, with rework modes applicable to each.

23. The method of claim 21, in which each UPP comprises input transport rates from an upstream UPP, and output transport rates to a downstream UPP, input and output storage buffers for work in process, and a unit process step.

24. The method of claim 21, in which algorithms are applied to calculate the productivity metrics of unit based overall equipment effectiveness (OEE), cycle time effectiveness (CTE), production throughput of good product (P_{g}) and UPP inventory level (Lᵤₚₚ), based on any one or more of the following: factory data for equipment time parameters, theoretical cycle time, actual cycle time, arrival and departure rates, and input and output buffer levels.

25. The method of claim 21, in which algorithms are applied to calculate UPP subsystem and/or system level productivity metrics of overall throughput effectiveness (OTE_{F}), cycle time effectiveness (CTE_{F}), production throughput of good product (P_{G(F)}) and UPP subsystem or factory inventory level (L_{F}), based on factory data and the productivity metrics for each UPP.

26. The method of claim 21, in which measurement, monitoring and quantitative calculation of the productivity metrics for the UPPs, the UPP subsystems, and/or production system is conducted using spreadsheet analysis tools which represent an actual factory architecture or the system.

27. The method of claim 26, in which measurement, monitoring and quantitative calculation of the productivity metrics for the UPPs, the UPP subsystems, and systems is conducted using a flowchart tool and a graphical user interface for data input and metrics output in appropriate spreadsheet or chart format.

28. The method of claim 27, comprising:
creating UPPs required to represent the generic subsystem types,
creating data input and metrics output boxes for standard input and output of data and results,
linking the UPPs to represent the experimental material flow sequence, or system architecture, with recognition algorithms applied to identify generic subsystem types, and
calculating productivity metrics for each UPP, UPP subsystem, and the overall system.

29. The method of claim 28, in which the UPPs include regular, assembly and expansion.

30. The method of claim 21, further comprising building an automated simulation model comprising importing data in spreadsheet form from a flowcharting and measurement tool, and representing interconnectivity of the system and actual and theoretical performance characteristics.

31. The method of claim 21, in which the simulation model comprises a rapid what-if scenario analysis of existing production facilities or systems, wherein specific changes needed for bottleneck removal and productivity improvement are identified.

32. The method of claim 21, in which the scenario analysis is linked to market demand.

33. The method of claim 21, in which the simulation model comprises rapid assessment and development of new factory designs optimized for specific manufacturing performance.

34. The method of claim 21, wherein the UPP includes anyone or more of the following: equipment, subsystem, product line, manufacturing process, factory, transportation system, and supply chains (which includes transportation systems and manufacturing systems).

35. The method of claim 21, wherein measurement and analysis of the system are conducted using a spreadsheet analysis and a visual flowcharting and measurement tool coded with the algorithms for unit-based productivity measurement, for single or multiple product types, at the equipment, subsystem and system level.

36. The method of claim 33, wherein the measurement and analysis of the system is conducted for single and multiple product types.

37. The method of claim 35, wherein data representing interconnectivity of the system and intrinsic performance characteristics are transferred from the flowcharting and measurement tool via at least one spreadsheet to set up an equivalent manufacturing array in a discrete event simulation software package.

38. The method of claim 37, wherein development and implementation of a dynamic simulation used to assess scenarios for eliminating bottlenecks and tailoring performance, and to develop new designs optimized for specific requirements in the production system.

39. The method of claim 21, wherein the production system includes any one or more of the following: equipment, subsystem, product line, manufacturing process, factory, transportation system, and supply chains (which includes transportation systems and manufacturing systems).

40. The method of claim 21, wherein the method is used to analyze overall equipment effectiveness.

41. The method of claim 21, wherein the system layout or architecture is determined by factoring the system into unique combinations of UPP subsystems.

42. A method for analysis of system level productivity comprising:
a) establishing a unique layout or architecture for arranging at least one set of unit production processes (UPPs) in a complex system;
b) calculating overall equipment effectiveness (OEE) and, optionally, other parameters of individual UPP's;
c) calculating overall throughput effectiveness (OTE_{F}) of the UPP subsystems and the system;
d) calculating good production output (P_{G(F)}) of the UPP subsystems and the system;
e) calculating cycle time efficiency (CTE_{F}) of the UPP subsystems and the system; and
f) calculating factory level inventory (L_{F}) of the UPP subsystems and the system.

43. The method of claim 42, wherein the system layout or architecture is determined by factoring the complex system into unique combinations of UPP subsystems.

44. The method of claim 42, in which the UPP subsystems include any one or more of the following: series, parallel, assembly, expansion, and complex, with rework modes applicable to each.

45. The method of claim 42, in which each UPP comprises input transport rates from an upstream UPP, and output transport rates to a downstream UPP, input and output storage buffers for work in process, and a unit process step.

46. The method of claim 42, in which algorithms are applied to calculate the productivity metrics of unit based overall equipment effectiveness (OEE), cycle time effectiveness (CTE), production throughput of good product (P_{g}) and UPP inventory level (Lᵤₚₚ), based on any one or more of the following: factory data for equipment time parameters, theoretical cycle time, actual cycle time, arrival and departure rates, and input and output buffer levels.

47. The method of claim 42, in which algorithms are applied to calculate UPP subsystem and/or system level productivity metrics of overall throughput effectiveness (OTE_{F}), cycle time effectiveness (CTE_{F}), production throughput of good product (P_{G(F)}) and UPP subsystem or factory inventory level (L_{F}), based on factory data and the productivity metrics for each UPP.

48. The method of claim 42, in which measurement, monitoring and quantitative calculation of the productivity metrics for the UPPs, the UPP subsystems, and/or production system is conducted using spreadsheet analysis tools which represent an actual factory architecture or the system.

49. The method of claim 48, in which measurement, monitoring and quantitative calculation of the productivity metrics for the UPPs, the UPP subsystems, and systems is conducted using a flowchart tool and a graphical user interface for data input and metrics output in appropriate spreadsheet or chart format.

50. The method of claim 49, comprising:
creating UPPs required to represent the generic subsystem types,
creating data input and metrics output boxes for standard input and output of data and results,
linking the UPPS to represent the experimental material flow sequence, or system architecture, with recognition algorithms applied to identify generic subsystem types, and
calculating productivity metrics for each UPP, UPP subsystem, and the overall system.

51. The method of claim 50, in which the UPPs include regular, assembly and expansion.

52. The method of claim 42, further comprising building an automated simulation model comprising importing data in spreadsheet form from a flowcharting and measurement tool, and representing interconnectivity of the system and actual and theoretical performance characteristics.

53. The method of claim 42, in which the simulation model comprises a rapid what-if scenario analysis of existing production facilities or, systems, wherein specific changes needed for bottleneck removal and productivity improvement are identified.

54. The method of claim 42, in which the scenario analysis is linked to market demand.

55. The method of claim 42, in which the simulation model comprises rapid assessment and development of new factory designs optimized for specific manufacturing performance.

56. The method of claim 42, wherein the UPP includes any one or more of the following equipment, subsystem, product line, manufacturing process, factory, transportation system, and supply chains (which includes transportation systems and manufacturing systems).

57. The method of claim 42, wherein measurement and analysis of the system are conducted using a spreadsheet analysis and a visual flowcharting and measurement tool coded with the algorithms for unit-based productivity measurement at the equipment, subsystem and system level.

58. The method of claim 42, wherein the measurement and analysis of the system is conducted for single and/or multiple product types.

59. The method of claim 57, wherein data representing interconnectivity of the system and intrinsic performance characteristics are transferred from the flowcharting and measurement tool via at least one or more spreadsheets to set up an equivalent manufacturing array in a discrete event simulation software package.

60. The method of claim 59, wherein development and implementation of a dynamic simulation is used to assess scenarios for eliminating bottlenecks and tailoring performance, and to develop new designs optimized for specific requirements in the production system.

61. The method of claim 42, wherein the production system includes any one or more of the following: equipment, subsystem, product line, manufacturing process, factory, transportation system, and supply chains (which includes transportation systems and manufacturing systems).

62. The method of claim 42, wherein the method is used to analyze overall equipment effectiveness.

63. The method of claim 42, wherein the system layout or architecture is determined by factoring the system into unique combinations of UPP subsystems.

64. A computer system for relating productivity to a production system to provide an integrated productivity analysis of the system comprising:
a) identifying an array of production operations including any one or more of the following: process, transportation and storage;
b) modeling the system as an interconnected array of unit production processes (UPP) reflecting actual or desired material flow sequence through the system;
c) applying at least one set of UPP interconnections to factor the system into at least one set of UPP subsystems for description and analysis; and
d) assessing each UPP and each subsystem to calculate at least one productivity metric of each UPP, UPP subsystem and the system.

65. A computer system of claim 64, in which the UPP subsystems include any one or more of the following: series, parallel, assembly, expansion, and complex, with rework modes applicable to each.

66. A computer system of claim 64, in which each UPP comprises input transport rates from an upstream UPP, and output transport rates to a downstream UPP, input and output storage buffers for work in process, and a unit process step.

67. A computer system of claim 64, in which algorithms are applied to calculate the productivity metrics of unit based overall equipment effectiveness (OEE), cycle time effectiveness (CTE), production throughput of good product (P_{g}) and UPP inventory level (Lᵤₚₚ) based on any one or more of the following: factory data for equipment time parameters, theoretical cycle time, actual cycle time, arrival and departure rates, and input and output buffer levels.

68. A computer system of claim 64, in which algorithms are applied to calculate UPP subsystem and/or system level productivity metrics of overall throughput effectiveness (OTE_{F}), cycle time effectiveness (CTE_{F}), production throughput of good product (P_{G(F)}) and UPP subsystem or factory inventory level (L_{F}), based on factory data and the productivity metrics for each UPP.

69. A computer system of claim 64, in which measurement, monitoring and quantitative calculation of the productivity metrics for the UPPs, the UPP subsystems, and/or production system is conducted using spreadsheet analysis tools which represent an actual factory architecture or the system.

70. A computer system of claim 64, in which measurement, monitoring and quantitative calculation of the productivity metrics for the UPPs, the UPP subsystems, and systems is conducted using a flowchart tool and a graphical user interface for data input and metrics output in appropriate spreadsheet or chart format.

71. A computer system of claim 70, comprising:
creating UPPs required to represent the generic subsystem types,
creating data input and metrics output boxes for standard input and output of data and results,
linking the UPPs to represent the experimental material flow sequence, or system architecture, with recognition algorithms applied to identify the generic subsystem types, and
calculating productivity metrics for each UPP, UPP subsystem, and the overall system.

72. A computer system of claim 71, in which the UPPs include regular, assembly and expansion.

73. A computer system of claim 64, further comprising building an automated simulation model comprising importing data in spreadsheet form from a flowcharting and measurement tool, and representing interconnectivity of the system and actual and theoretical performance characteristics.

74. A computer system of claim 64, in which the simulation model comprises a rapid what-if scenario analysis of existing production facilities or systems, wherein specific changes needed for bottleneck removal and productivity improvement are identified.

75. A computer system of claim 64, in which the scenario analysis is linked to market demand.

76. A computer system of claim 64, in which the simulation model comprises rapid assessment and development of new factory designs optimized for specific manufacturing performance.

77. A computer system of claim 64, wherein the UPP includes any one or more of the following: equipment, subsystem, product line, manufacturing process,, factory, transportation system, and supply chains (which includes transportation systems and manufacturing systems).

78. A computer system of claim 64, wherein measurement and analysis of the system are conducted using a spreadsheet analysis and a visual flowcharting and measurement tool coded with the algorithms for unit-based productivity measurement at the equipment, subsystem and system level.

79. A computer system of claim 78, wherein the measurement and analysis of the system is conducted for single and/or multiple product types.

80. A computer system of claim 64, wherein data representing interconnectivity of the system and intrinsic performance characteristics are transferred from the flowcharting and measurement tool via at least one or more appropriate spreadsheets to set up an equivalent manufacturing array in a discrete event simulation software package.

81. A computer system of claim 80, wherein development and implementation of a dynamic simulation is used to assess scenarios for eliminating bottlenecks and tailoring performance, and to develop new designs optimized for specific requirements in the production system.

82. A computer system of claim 64, wherein the production system includes any one or more of the following: equipment, subsystem, product line, manufacturing process, factory, transportation system, and supply chains (which includes transportation systems and manufacturing systems).

83. A computer system of claim 64, wherein the method is used to analyze overall equipment effectiveness.

84. A computer system for hierarchical representation of a production system for measuring, monitoring, analyzing and/or simulating production performance of the production system based on a common set of productivity metrics for throughput effectiveness, cycle time effectiveness, throughput and inventory, comprising:
a) identifying an array of production operations including any one or more of the following: process, transportation, and storage; .
b) providing a description of the production system as an interconnected array of unit production processes (UPP) reflecting an actual material flow sequence through the system;
c) applying at least one set of UPP subsystems to factor an overall system flowchart into UPP subsystems, and combining the subsystems to represent the overall production system;
d) analyzing productivity metrics of each UPP, each UPP subsystem, and the overall system; and
e) converting the flowchart to a discrete event simulation description, and enabling comparative performance assessment of various production scenarios useful for performance improvement and system design.

85. A computer program product comprising a program storage device readable by a computer system tangibly embodying a program of instructions executed by the computer system to perform in a process for causally relating productivity to a production system, the process comprising:
a) identifying an array of production operations including any one or more of the following: process, transportation and storage;
b) modeling the system as an interconnected array of unit production processes (UPP) reflecting actual or desired material flow sequence through the system;
c) applying at least one set of UPP interconnections to factor the system into at least one set of UPP subsystems for description and analysis; and
d) assessing each UPP and each subsystem type to calculate at least one productivity metric of each UPP, UPP subsystem and the system.

86. The method of claim 85, in which the UPP subsystems include any one or more of the following: series, parallel, assembly, expansion, and complex, with rework modes applicable to each.

87. The method of claim 85, in which each UPP comprises input transport rates from an upstream UPP, and output transport rates to a downstream UPP, input and output storage buffers for work in process, and a unit process step.

88. The method of claim 85, in which algorithms are applied to calculate the productivity metrics of unit based overall equipment effectiveness (OEE), cycle time effectiveness (CTE), production throughput of good product (P_{g}) and UPP inventory level (Lᵤₚₚ), based on any one or more of the following: factory data for equipment time parameters, theoretical cycle time, actual cycle time, arrival and departure rates, and input and output buffer levels.

89. The method of claim 85, in which algorithms are applied to calculate UPP subsystem and/or system level productivity metrics of overall throughput effectiveness (OTE_{F}), cycle time effectiveness (CTE_{F}), production throughput of good product (P_{G(F)}) and UPP subsystem or factory inventory level (L_{F}), based on factory data and the productivity metrics for each UPP.

90. The method of claim 85, in which measurement, monitoring and quantitative calculation of the productivity metrics for the UPPs, the UPP subsystems, and/or production system is conducted using spreadsheet analysis tools which represent an actual factory architecture or the system.

91. The method of claim 85, in which measurement, monitoring and quantitative calculation of the metrics for the UPPS, the UPP subsystems, and systems is conducted using a flowchart tool and a graphical user interface for data input and metrics output in appropriate spreadsheet or chart format.

92. The method of claim 91, comprising:
creating UPPs required to represent the generic subsystem types,
creating data input and metrics output boxes for standard input and output of data and results,
linking the UPPs to represent the experimental material flow sequence, or system architecture, with recognition algorithms applied to identify the generic subsystem types, and
calculating productivity metrics for each UPP, UPP subsystem, and the overall system.

93. The method of claim 92, in which the UPPs include regular, assembly and expansion.

94. The method of claim 85, further comprising building an automated simulation model comprising importing data in spreadsheet form from a flowcharting and measurement tool, and representing interconnectivity of the system and actual and theoretical performance characteristics.

95. The method of claim 85, in which the simulation model comprises a rapid what-if scenario analysis of existing production facilities or systems, wherein specific changes needed for bottleneck removal and productivity improvement are identified.

96. The method of claim 85, in which the scenario analysis is linked to market demand.

97. The method of claim 85, in which the simulation model comprises rapid assessment and development of new factory designs optimized for specific manufacturing performance.

98. The method of claim 85, wherein the UPP includes any one or more of the following: equipment, subsystem, product line, manufacturing process, factory, transportation system, and supply chains (which includes transportation systems and manufacturing systems).

99. A computer program of claim 85, wherein measurement and analysis of the system are conducted using a spreadsheet analysis and a visual flowcharting and measurement tool coded with the algorithms for unit-based productivity measurement at the equipment, subsystem and system level.

100. The method of claim 99, wherein the measurement and analysis of the system is conducted for single and/or multiple product types.

101. A computer program of claim 99, wherein data representing interconnectivity of the system and intrinsic performance characteristics are transferred from the flowcharting and measurement tool via at least one or more spreadsheets to set up an equivalent manufacturing array in a discrete event simulation software package.

102. A computer program of claim 101, wherein development and implementation of a dynamic simulation is used to assess scenarios for eliminating bottlenecks and tailoring performance, and to develop new designs optimized for specific requirements in the production system.

103. A computer program of claim 85, wherein the production system includes any one or more of the following: equipment, subsystem, product line, manufacturing process, factory, transportation system, and supply chains (which includes transportation systems and manufacturing systems).

104. A computer program of claim 85, wherein the method used to analyze overall equipment effectiveness.
